(19) United States
(12) Patent Application Publication
(10) Pub. No.: US 2024/0374462 A1
(43) Pub. Date: Nov. 14, 2024

(54) REMOVABLE SKIN INTERFACE FOR FUNCTIONAL ENHANCEMENT OF HANDHELD VIBRATIONAL DEVICE

(71) Applicant: Olympic Ophthalmics, Inc., Issaquah, WA (US)

(72) Inventor: Michael Gertner, Menlo Park, CA (US)

(73) Assignee: Olympic Ophthalmics, Inc., Issaquah, WA (US)

(21) Appl. No.: 18/605,624

(22) Filed: Mar. 14, 2024

Related U.S. Application Data
(60) Provisional application No. 63/464,944, filed on May 9, 2023.

(51) Int. Cl. A61H 7/00; A61H 5/00; A61H 23/02

(52) U.S. Cl. CPC A61H 7/005; A61H 5/00; A61H 23/0263; A61H 2201/1685

(57) ABSTRACT

An accessory device for coupling with an end-effector of a vibration device, the end-effector of the vibration device configured to provide a first treatment effect for a user of the vibration device, the accessory device includes: a housing configured to accommodate at least a part of the end-effector, the housing comprising an opening configured to allow the part of the end-effector to be inserted therein; and an accessory end-effector extending from the housing, wherein the accessory end-effector is configured to provide a second treatment effect for the user of the vibration device that is different from the first treatment effect.

### RELATED APPLICATION DATA

This application claims priority to, and the benefit of, U.S. Provisional Patent Application No. 63/464,944 filed on May 9, 2023, pending. The entire disclosure of the above application is expressly incorporated by reference herein.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### TECHNICAL FIELD

The present disclosure relates generally to medical devices and methods. More particularly, the present disclosure relates to devices and methods for stimulating or inhibiting nerves and/or treating conditions, such as congestion, keratoconjunctivitis sicca, sinusitis, carpal tunnel syndrome, eye conditions, a skin condition, acne, cysts, or any other condition.

### BACKGROUND

New methods and devices for treating different medical conditions, specifically dry eye syndrome, are described herein.

“Dry eye” is the world's most common eye disease. “Dry eye” indicates the lack of quantity and/or quality of the tear film. In the human eye, the tear film covering the ocular surfaces is composed of three layers. The innermost layer in contact with the ocular surface is the mucus layer, comprised of many mucins. The middle layer, comprising the bulk of the tear film, is the aqueous (water) layer, and the outermost layer is a thin (less than 250 nm) layer (“lipid layer”) comprised of many lipids. The typical upper eyelid has about 25 meibomian glands and the lower eyelid has about 20 meibomian glands. The meibomian gland orifices open onto the eyelid margin at and around the junction of the inner mucous membrane and the outer skin of the eyelids; that junction is termed the mucocutaneous junction.

Meibomian glands of mammalian (e.g., human) eyelids secrete oils that prevent evaporation of the tear film and provide lubrication to the eye and eyelids. These glands can become blocked or plugged by various mechanisms leading to so-called “dry eye syndrome”. While not the only cause, meibomian gland dysfunction is a major cause of dry eye syndrome. Dry eye syndrome is characterized by a blockage of the meibomian glands, which prevents normal lipid secretions from flowing from the meibomian glands to form the lipid layer of the tear film.

Dry eye is exacerbated by eyelid margin debris and bacterial overgrowth, daily eyelid hygiene is often prescribed by physicians and recommended by health institutions worldwide. This is for the life of the patient, because, as mentioned, dry eye is chronic, with no known cure: unless proper eyelid hygiene is instituted, dry eye syndrome will only worsen with age.

Since dry eye is exacerbated by eyelid margin debris and bacterial overgrowth, daily eyelid hygiene is often prescribed by physicians and recommended by health institutions worldwide.

Commercial “eyelid scrubs” are available in several forms, such as impregnated, pre-moistened towelettes or pads, or as bottled cleansers applied to a non-sterile applicator pad or to fingertips, such eyelid scrubs do not improve patient compliance or efficacy. These rely on the individual to perform vigorous back and forth scrubbing of all four eyelid margins, which is cumbersome, time consuming, sometimes painful, and has uneven results. All of these disadvantageous are strong disincentives for a patient to follow an eyelid cleaning regimen.

### SUMMARY

An accessory device for coupling with an end-effector of a vibration device, the end-effector of the vibration device configured to provide a first treatment effect for a user of the vibration device, the accessory device includes: a housing configured to accommodate at least a part of the end-effector, the housing comprising an opening configured to allow the part of the end-effector to be inserted therein; and an accessory end-effector extending from the housing, wherein the accessory end-effector is configured to provide a second treatment effect for the user of the vibration device that is different from the first treatment effect.

Optionally, the housing comprises a first end, and a second end opposite from the first end, wherein the opening is at the first end of the housing.

Optionally, the accessory end-effector comprises a plurality of bristles.

Optionally, the bristles are at the second end of the housing, and are opposite from the first opening.

Optionally, the bristles are configured to be vibrated by the vibration device in a direction that is parallel to a longitudinal axis of one of the bristles, when the accessory device is coupled to the vibration device.

Optionally, the plurality of bristles comprises a first row of bristles arranged in a first rectilinear configuration.

Optionally, the plurality of bristles further comprises a second row of bristles arranged in a second rectilinear configuration.

Optionally, the plurality of bristles further comprises a third row of bristles arranged in a third rectilinear configuration.

Optionally, at least one of the bristles has a cross-sectional dimension that is less than 1 mm.

Optionally, at least one of the bristles has a cross-sectional dimension that is larger than 0.5 mm.

Optionally, at least one of the bristles has a cross-sectional dimension that is larger than 1 mm.

Optionally, at least one of the bristles has a length that is 2 mm.

Optionally, at least one of the bristles has a length that is longer than 2 mm.

Optionally, at least one of the bristles has a length that is shorter than 2 mm.

Optionally, the plurality of bristles comprises 24 bristles.

Optionally, the plurality of bristles comprises more than 24 bristles.

Optionally, the plurality of bristles comprises fewer than 24 bristles.

Optionally, the bristles comprise respective tips, and wherein the tips of the respective bristles define a curvilinear surface.

Optionally, one of the bristle has a flexibility that allows a tip of the one of the bristles to displace by at least 1 mm in response to a 0.5N force applied at the tip in a direction that is perpendicular to a longitudinal axis of the one of the bristles.

Optionally, the housing has an outer dimension measured in a direction that is parallel to one of the bristles, the outer dimension being anywhere from 5 mm to 9 mm.

Optionally, the bristles are configured to stimulate the meibomian glands when the bristles are vibrated by the vibration device.

Optionally, the housing has a wall thickness that is anywhere from 0.25 mm to 1.5 mm.

Optionally, the housing is configured to attach to the part of the end-effector via friction.

Optionally, the housing is configured to attach to the part of the end-effector via a double-sided tape.

Optionally, the housing is configured to attach to the part of the end-effector via an adhesive.

Optionally, the housing is configured to attach to the part of the end-effector via a mechanical coupler.

Optionally, the housing is configured to attach to the part of the end effector with a coupling force that is sufficient to withstand a vibration of the end-effector at 100 Hz.

Optionally, the housing is configured to attach to the part of the end-effector with a coupling force that is sufficient to withstand a vibration of the end effector at 200 Hz.

Optionally, the housing is configured to attach to the part of the end-effector with a coupling force that is sufficient to withstand a vibration of the end effector at 300 Hz.

Optionally, the accessory end-effector is configured to replace, enhance, or alter a function of the end-effector of the vibration device.

Optionally, the accessory device is a part of system that comprises the vibration device.

Optionally, the vibration device is configured to provide mechanical vibration to treat a dry eye condition of a user.

Optionally, the vibration device comprises: a housing; a member having a first portion accommodated in the housing, and a second portion that is moveable relative to the housing, wherein the second portion is for placement outside a user and comprises the end-effector, the member having an elongated configuration; and a motor in the housing, the motor configured to oscillate the member.

Optionally, the motor is carried by the member.

Optionally, the motor is fixedly attached to the member so that the motor and the member can move together.

Optionally, the member comprises a cantilevered beam having a free end, the second portion being at the free end of the cantilevered beam.

Optionally, a weight of the motor is supported by the member.

Optionally, the motor has a motor housing, and the motor housing is attached to the member.

Optionally, the motor comprises a shaft, and the vibration device comprises an eccentric mass secured to a shaft of the motor.

Optionally, the vibration device comprises an electrical wire connected to the motor, wherein at least a portion of the electrical wire is coupled to the member.

Optionally, the member has a first bending stiffness in a first bending direction, and a second bending stiffness in a second bending direction, the second bending stiffness being higher than the first bending stiffness.

Optionally, the first bending direction corresponds with a direction of oscillation of the member.

Optionally, the member has a cross section with a first side and a second side, the first side being longer than the second side, and wherein the motor is attached to the first side.

Optionally, the end-effector has a curvilinear surface.

Optionally, the end-effector is outside the housing.

Optionally, the housing comprises a structure to hold a fluid or a gel

Optionally the housing comprises silicone, hydrogel, polyurethane, or any of other suitable materials.

Other features and aspects will be described in the detailed description.

### BRIEF DESCRIPTION OF THE DRAWINGS

The novel features are set forth with particularity in the appended clauses. A better understanding of the features and advantages will be obtained by reference to the following detailed description that sets forth illustrative embodiments and the accompanying drawings of which:

FIG. 1 depicts a tear duct with inspissated material.

FIG. 2 depicts a device to deliver vibrational energy to the nasal turbinates and nerves inside the nasal cavity via contact through the skin and bony structures of the nose.

FIG. 3 depicts a coronal section through the sinuses

FIG. 4 depicts a coronal section through the face with the tear duct anatomy outlined.

FIG. 5 illustrates an ultrasound transducer adapted to apply ultrasound energy to the tissues of the nasal cavity.

FIG. 6 depicts the interface between an ultrasound device and the tissues of the face.

FIG. 7 depicts a coronal view of the sinuses.

FIG. 8 depicts an assembly schematic for a device to apply vibrating energy to nerve trigger points on a face.

FIG. 9 depicts the bony and soft tissue structures in and around the nose.

FIG. 10 depicts the nerve anatomy in and around the nose.

FIG. 11 depicts an embodiment of a handheld tear stimulator.

FIG. 12 depicts an expanded view of a handheld neurostimulator to create tears.

FIG. 13 depicts an expanded view of a neurostimulator device.

FIG. 14 depicts an expanded view of another neurostimulator device.

FIG. 15 depicts a device which applies mechanical vibration bilaterally to a patient.

FIG. 16 depicts the device in FIG. 15 in more detail.

FIG. 17 depicts the inner mechanism of a device to create tears in a patient.

FIG. 18 depicts a device which generates linear vibratory motion to be applied to the skin or eye of a patient.

FIG. 19A depicts a carpal ligament and median nerve of a wrist.

FIG. 19B depicts a transverse section of a wrist.

FIG. 20 depicts various mechanisms through which a pore becomes plugged.

FIG. 21 depicts another embodiment of a device which generates vibratory motion to be applied to the skin or eye of a patient.

FIG. 22 depicts the device of FIG. 21 being applied to the junction of the nasal bone and the anterior lateral nasal cartilage

FIG. 23 is a schematic representation of one embodiment of the device of FIG. 21.

FIG. 24 depicts a cross-sectional view of one embodiment of the device of FIG. 21.

FIG. 25 depicts various dimensions of the device of FIG. 21.

FIG. 26 depicts another embodiment of a device which generates vibratory motion to be applied to an eye structure (e.g., lid, eyeball, etc.) of a patient.

FIG. 27 depicts a test fixture for testing a device which generates vibratory motion.

FIG. 28A depicts a frequency and amplitude of an effector tip of a device with one embodiment of a cantilever beam.

FIG. 28B depicts a frequency and amplitude of an effector tip of a device with another embodiment of a cantilever beam.

FIG. 29A depicts a side view of an end effector of a clinically effective device according to Table 1.

FIG. 29B depicts a top view of an end effector of a clinically effective device according to Table 1.

FIG. 30A depicts a side view of an end effector of a clinically ineffective device according to Table 1.

FIG. 30B depicts a top view of an end effector of a clinically ineffective device according to Table 1.

FIG. 31 depicts equations for calculating natural frequency of a cantilever beam.

FIG. 32 shows a vibration device with an end effector, and an accessory device.

FIG. 33 shows a side view of the accessory device of FIG. 32.

FIG. 34 shows a perspective view of the accessory device of FIG. 32.

FIG. 35A shows a perspective view of the accessory device of FIG. 32.

FIG. 35B-35G shows exemplary dimensions of the accessory device of FIG. 32.

FIG. 36A shows an exemplary height of the accessory device of FIG. 32.

FIG. 36B shows another exemplary height of the accessory device of FIG. 32.

FIG. 37 shows the device of FIG. 32 with an accessory device attached.

FIG. 38 shows another vibration device.

### DETAILED DESCRIPTION

Various embodiments are described hereinafter with reference to the figures. It should be noted that the figures are drawn to scale in some embodiments, but may have different dimensions or shapes from that shown in the figures in other embodiments. Also, elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described. One or more of the embodiments described herein pertain to utilizing mechanical force to treat disorders of the eye including disorders of the front of the eye and the back of the eye.

Sound, ultrasound, and vibration are utilized interchangeably in this disclosure. Mechanical vibration at audible frequencies (20 to 20,000 Hz) may or may not actually transmit audible sound waves but may transmit force to a surface and is included in the broad definition of sound and ultrasound. Vibration, or mechanical vibration, is the broadest term and encompasses all sound or ultrasound regardless of whether pressure waves are created. Sound is simply mechanical vibration which transmits pressure waves through a medium which is then processed and “heard.” Vibration as a category encompasses ultrasound and sound as well as mechanical vibration which may not result in sound. For example, mechanical vibration may be delivered by a probe with a linear motion, a planar motion, or motion in all three axes. The important aspect of mechanical vibration is the motion and a frequency of at least a few Hertz (Hz). The underlying mechanism of purposeful vibration (as opposed to unwanted vibration created incidentally to another mechanism such as a running motor) is to and from motion intentionally created by a moving mechanism along with transduction to another medium, for example, a body tissue of a human subject. The motion of the vibration can be created by a number of different mechanisms including motors with a gear and camshaft to create an offset, an eccentric motor, a linear resonant actuator, a voice coil, and a piezoelectric mechanism. In this respect, mechanical vibration is easier to create than sound.

The frequency of the sound waves may range from the low frequency sub audible range to the higher frequency inaudible ultrasound range. Devices described herein treat dry eye by increasing the amount of tears in the eye or treat congestion by activating nerves in the nose region. These devices act synergistically with devices which improve the quality of the tear film. These devices create tears by activating the sphenopalatine ganglion (indirectly or directly) and/or facial nerve branches, and/or ethmoidal nerves with ultrasound or sound or mechanical vibration externally applied through the skin of the nose. An example of a direct stimulation of the sphenopalatine ganglia is through stimulation of the ganglia itself. An example of indirect stimulation of the sphenopalatine ganglia is through activation of a sensory pathway which then communicates via reflex neural circuit to the sphenopalatine ganglia to increase output or tears. Another embodiment can treat a variety of disorders utilizing sound and/or ultrasound and/or vibration which is externally applied to the skin of the head and neck and activates nerves or nerve ganglia under the skin. Another embodiment applies vibratory energy to the mucosa inside of the nose or to the mucosa on the inside of the eyelids to treat dry eye.

The nasolacrimal apparatus is the physiological system containing the orbital structures for tear production and drainage. It consists of the lacrimal gland, the lacrimal canaliculi, and the nasolacrimal duct which communicates with the cavity of the nose. The innervation of the lacrimal apparatus involves both the sympathetic supply through the carotid plexus of nerves around the internal carotid artery, and parasympathetically from the lacrimal nucleus of the facial nerve in the brainstem. Signals travel from sensory (afferent) fibers around the face to the area of the salivary nucleus in the brainstem to activate the parasympathetic fibers which travel back to the sphenopalatine ganglia to synapse and then send terminal nerve fibers to innervate the lacrimal gland.

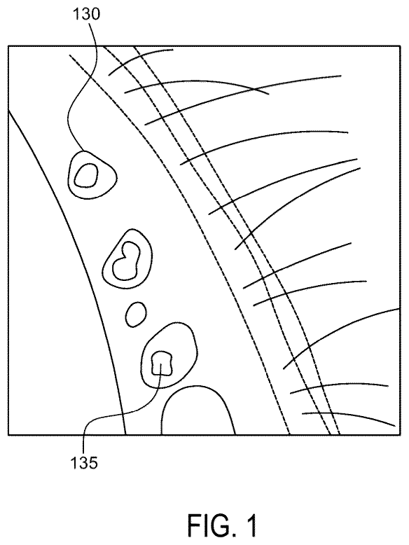

As shown in FIG. 1, tear ducts 130 may contain inspissated oils, or may be otherwise blocked with material 135 preventing tears or tear components (e.g. oils, lipids, etc.) from being excreted into the tear film 160 of the eye. In one example, a disease which is treated by the methods and devices described herein is dry eye.

In another embodiment, eyelash growth is stimulated with mechanical vibration. For example, it has been shown in previous models in bone tissue that ultrasound delivered at 50 kHz and 1 MHz stimulates prostaglandin release (Bone 2002 Jul. 31; 236-41). Prostaglandin release has been considered the main mechanism of action for the pharmaceutical agent bimatoprost, an FDA approved agent to stimulate eye lash growth. Therefore, in one embodiment, a vibratory stimuli is utilized to upregulate prostaglandin synthesis and increase thickness of eyelashes in a subject. Indeed, any of the embodiments herein may be combined with pharmaceuticals.

Ultrasound, sound, or vibration can be used to heat and/or vibrate the material 135 to remove it from the duct 130, as shown in FIG. 1. In some embodiments, the ultrasound frequency chosen is one which resonates at the interface of the duct and the inspissated material to dislodge or heat the material in the duct so that the secretions from the duct can reach the eye and prevent dry eye. For example, early work has shown that sound frequencies in the 100 Hz to 500 Hz range will lead to break up of the material in the inspissated ducts. When combined with higher frequency ultrasound energy (e.g. 1 MHz to 3 MHZ), the material can be heated to improve the efficiency of the unblocking of the ducts. In some embodiments, temperature measurement is utilized to facilitate the safety and efficacy of the treatment; a temperature range of between 40 and 48 Celsius is the preferred temperature. The temperature can be controlled with closed loop control in which a thermistor is utilized to measure temperature and then the feedback through a control circuit is utilized to control the power output so as to maintain the temperature in a pre-specified range.

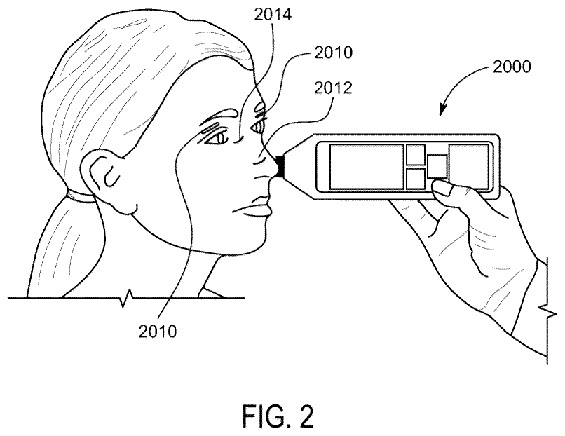

FIG. 2 depicts an embodiment of a device to stimulate the lacrimal gland or other nerves or ganglia transcutaneously through the skin to the nerves and ganglia. Regions 2012, 2014, and 2010 have been shown experimentally to produce the greatest amount of nerve stimulation by way of vibration of the facial bones which in turn stimulate the nerves such as sphenopalatine ganglia, lacrimal nerve, external nasal nerve, infratrochlear nerve, supratraochlear nerve, infraorbital nerve, supraorbital nerve etc. For example, region 2012, when exposed to direct skin vibration at approximately 100 Hz-300 Hz vibration produces copious bilateral tear formation and relieves congestion when just a single side is stimulated. In some embodiments, vibrations from about 50 Hz to about 500 Hz are utilized to stimulate the bones of the face to, in turn, transmit vibrations to the nerves which stimulate tear production. The treatment works best at the resonant frequency of the bone so that the vibration of the bone is maximal and affects the nerve maximally due to the greatest amount of mechanical movement of the nerve and subsequent stimulation. The resonant frequency of the bone is to some extent individualized per patient. This frequency has been experimentally determined and subsequently proven to be in the range of about 100-300 Hz.

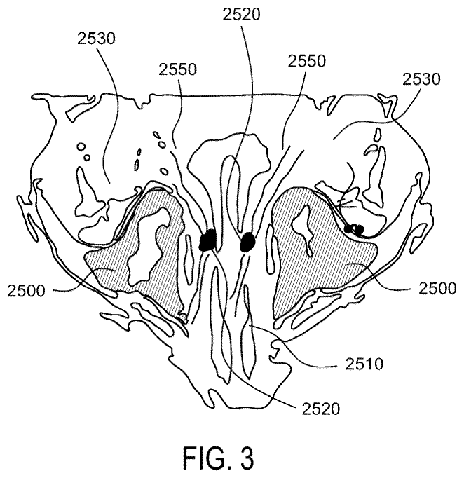

Region 2014 (FIG. 2) includes the bottom eyelid (inner and outer eyelid), the medial canthus of the eye along the nasolacrimal duct. External stimulation along these regions in some embodiments stimulates the nerves through bony resonance and, in some embodiments, stimulates the glands in the lower eyelid region directly. FIG. 3 depicts neural pathways involved in the transduction of vibration from the skin to the lacrimal gland when vibrations are applied through the preferred external location 2012 in FIG. 2. Ganglia 2520 projects nerves to the lacrimal nerve 2550 which courses to the orbit to stimulate the main lacrimal gland in the superior portion of the orbit. Bone 2530 transmits vibrations to the lacrimal nerve 2550 and around the maxillary sinus 2500 via the sphenopalatine ganglia. The sphenopalatine ganglia 2520 is covered by mucosa and sits between the turbinates which are accessible transnasally through the external nasal passageways 2510. The external nasal nerve is a terminal branch of the ophthalmic branch of the trigeminal nerve and is directly stimulated with vibration as it is compressed against its exit from underneath the nasal bone at the junction of the nasal bone and the anterior lateral nasal cartilage. In another embodiment, an ultrasound or sound producing probe is inserted through the external nasal passageways 2510 and applied to the mucosa in proximity to the sphenopalatine ganglia 2520 to stimulate tear production through direct stimulation or via the nasolacrimal reflex. In another embodiment, a vibratory probe with vibration at approximately 100-300 Hz is inserted into the nasal passage to directly stimulate the sphenopalatine ganglia and/or the interior anterior ethmoidal nerves on the interior of the nasal passage. In another embodiment, electrical stimulation of the external nasal nerve accomplishes tearing by activating the lacrimal nucleus in the pons and subsequently pre-ganglionic fibers within the maxillary nerve which synapse in the sphenopalatine ganglia and then stimulate the lacrimal nerve to produce tears.

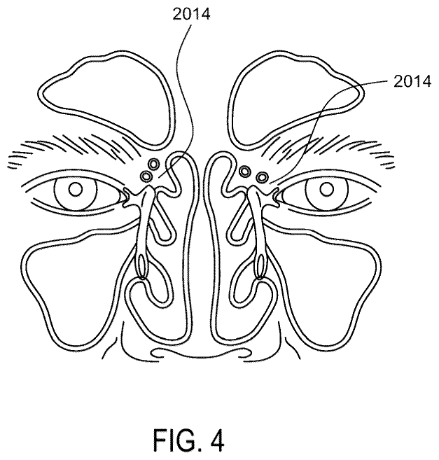

In one embodiment, a method to stimulate neural pathways through the application of sound or ultrasound energy transcutaneously is described. An applicator is disposed to the face of the patient, the applicator comprising one or more vibratory elements capable of generating vibrations from about 50 Hz to about 50 KHz. The vibration is applied to a region close to a nerve under the skin or to a region with a bony prominence which communicates via bone structure with a nerve region located close to the skin. For example, an applicator 2000 disposed to the region 2010, 2012 (FIG. 2) or 2014 (FIGS. 2, 4) will transmit the vibratory energy to the lacrimal glands and produce tears. The resonant frequency is different for each person as is the exact location and direction of the vibration. In one embodiment, the individual resonant frequency is determined and the device adjusted to this frequency for each person. An interface between the device and the patient's skin is similarly adjustable so that the vibrations are transmitted to the nerves in the head and neck region to be stimulated. For example, the parasympathetic nerve which innervates the lacrimal gland travels within the maxillary bone and the sphenopalatine ganglia is located close to the maxillary bone in the sphenopalatine fossa. At a resonant frequency of the maxillary bone, it has been discovered that the ganglia can be stimulated and tears produced. The resonant frequency is achieved through a combination of material, vibration frequency, and amplitude. For example, a material with a durometer between Shore A40 and Shore A60 vibrating over a surface area of between 5 mm² and 20 mm² with an amplitude of about 0.5 to 5 mm and frequency of between 50 Hz and 400 Hz results in copious tears. With a directionality upward and at a location approximately along the nasal bone where it meets the cartilage, tears can be produced without discomfort or sneezing or other nasal symptoms. The total force applied over the surface area in some embodiments is about 1N (Newton). In other embodiments, the total force is from about 0.5N to bout 2N. In other embodiments, the force is about 0.25N to about 4N.

In some embodiments, the device is connected to an iTEAR application on a smart phone. For example, the device communicates with a smart phone through a Bluetooth application or via wifi. The application on the smart phone might track usage of the device, the force applied to the cantilever of the device, the remaining power charge, the and the frequency of the device. In one embodiment, the application on the smart device takes a picture of the eye or eyes of the patient during the stimulation of the lacrimal glands. A subsequent or sequential set of images are compared to one another and the thickness of the tear film determined. The change in the tear film is determined based on a reflectance from the tear film as the result of a camera flash. Alternatively, a filter is utilized to determine the difference between pre-stimulation and post-stimulation. A custom light source can be driven by the smart device and the reflected light collected by the device. For example, an infrared, red, or blue light source can be hard wired to the device. A baseline picture is obtained and stimulation begun. The light is projected to the tear film and the tear film quantified through a series of baseline and during treatment pictures are obtained. In one embodiment, interferometry is obtained after the light is applied to the tear film.

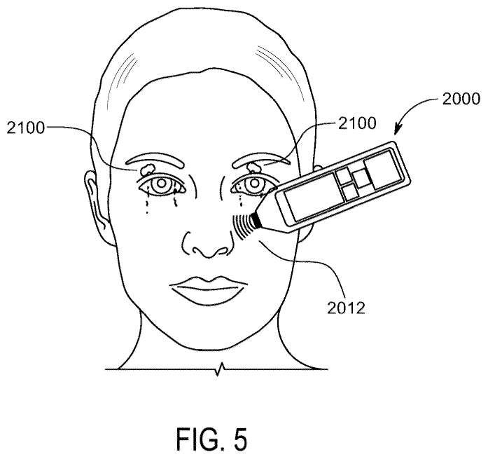

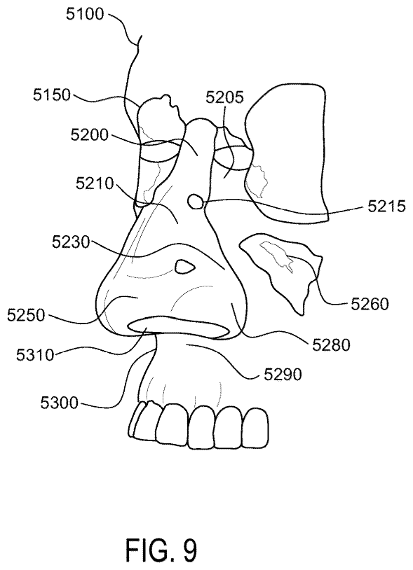

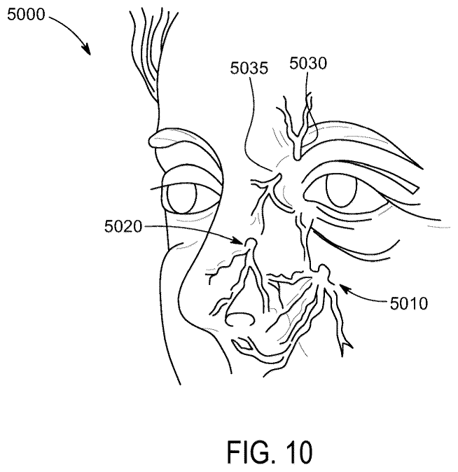

FIG. 9 depicts the bony anatomy of the face. FIG. 10 depicts the nervous anatomy of the face. In FIG. 10, at the point where the upper lateral cartilage meets the nasal bone, the external branch of the anterior ethmoidal nerve penetrates the nasal bone is depicted. This location is where the lateral process of the septal nasal cartilage meets the nasal bone (FIG. 9) and 2012 in FIG. 5. This is the location, located on the skin, which has been discovered through experimentation to produce tears when mechanical vibration is applied at a frequency of 50-300 Hz with a vibration amplitude of approximately 0.5 mm to 1.5 mm and/or force of about 0.5 to 1.5N.

Furthermore, it has been discovered that direct stimulation of the infratrochlear and infraorbital nerves with mechanical vibration also induces lacrimation. Mechanical vibration can also stimulate lacrimation by direct contact with the mucosal surfaces inside the nose.

FIG. 10 depicts the neural anatomy of this region underneath the skin. The anterior ethmoidal nerve, a direct continuation of the nasociliary nerve, splits into two branches to supply the nasal mucosa, medial and lateral, as it enters the nasal cavity where is supplies the nasal mucosa. The nasociliary nerve continues to the caudal region of the nasal bone and appears 6.5 mm to 8.5 mm from the midline as the external nasal nerve The infraorbital nerve 5010 exits the bone and travels into the skin approximately 1-2 cm below the lower eyelid. It is the external nasal nerve which has been determined to induce tearing when vibrations at 50-300 Hz are applied. Electrical stimulation (bipolar or monopolar) of the external nasal nerve in this region also can be utilized to induce lacrimation.

A well described pathway for lacrimation is called the nasolacrimal reflex in which stimulation of afferent fibers of the anterior ethmoidal nerve (accessible inside the nose) travel through the ophthalmic nerve to the salivary nucleus in the brain stem, then parasympathetic nerve signals travel via the maxillary branch of the trigeminal synapse in the sphenopalatine ganglia to innervate the lacrimal nerve and stimulate the lacrimal glands. Parasympathetic fibers generally stimulate the lacrimal glands and also partially innervate the Meibomian glands.

In addition to the specific descriptions set forth herein, it has been discovered through extensive experimentation that stimulation of the external nasal nerve achieves lacrimation. As described above, the external nasal nerve 5020 exits to the surface of the skin from deep to the layers of the skin through an orifice 5270 at the junction of the nasal cartilage 5240 and nasal bone 5210. It is not accessible by electrical stimulation. As described herein, certain vibrational parameters result in stimulation of lacrimation similar to the nasolacrimal reflex.

The external nasal nerve is a continuation of the nasociliary nerve which originates from the ophthalmic branch of the trigeminal nerve. Prior to its exit from the inner portion of the nose to the external portion of the nose, it gives off two branches to the inner portion of the nose. The external nasal branch is the terminal nerve of the nasociliary nerve. After exiting the inner portion of the nose between the nasal bone and the upper lateral cartilage (through a notch in the nasal bone), the external nasal nerve dips into the fibrofatty tissue to ultimately branch and supply the skin and fatty tissues of the distal nose. In an anatomic study, the exit of the nerve was consistently 6.5-8.5 mm lateral to the nasal midline independent of the width of nose. There were three branching patterns identified. The first was a single nerve exiting the nasal bone. The second pattern was splitting of the nerve upon exit from the nasal bone, and the third pattern was splitting of the nerve distal to the exit from the nasal bone close to the cartilage of the distal region of the nose. The nerve size in this study was consistently 0.3 mm to 0.4 mm diameter.

Therefore, in one embodiment, a device is placed approximately 6.5 to 8.5 mm lateral to the nasal midline at the region where the upper lateral cartilage meets the nasal bone. The device is placed unilaterally or bilaterally or unilaterally and then sequentially on the contralateral side for bilateral treatment. The device applies a force over an area of 1-2 mm² on the nose at frequency of 100-300 Hz. In some embodiments, approximately 0.5 to about 2.0N of force is applied to the external nasal nerve as it leaves the nasal bone. In other embodiments, a force of approximately 2 to about 5N is applied to the nose to activate the external nasal nerve. Despite extensive anatomic descriptions, until the current invention, there has been no description of the function of the nerve beyond the sensory distribution to the skin of the nose.

In another embodiment in FIG. 4, the nasolacrimal duct is the target. It has been found in clinical work that stimulation of this duct internally along its length leads to stimulation of tear production. The mechanism is thought to be direct stimulation of the nasolacrimal reflex. It has been further discovered that vibration at 100-500 Hz externally through the skin in the region of the bone through which the duct travels (e.g. nasal bone) also stimulates this reflex. Similar to the external nasal nerve, electrical stimulation has been found to be ineffective in the stimulation of the reflex through this anatomy

The effector interface with the face of the patient is a very important component of the energy transmission to promote safety and tolerability of the procedure. Through experimentation, the optimal durometer is somewhere between Shore 40 A (pencil eraser) and Shore 80 A (leather). Shore 60 A is about a car tire tread and Shore 70 A is a running shoe sole. With an interface which is too hard, the skin is abraded and with an interface which is too soft, the nerve is not effectively stimulated.

It has been determined that unfocused vibration at 50 Hz to about 300 Hz leads to general activation of the sphenopalatine ganglion, lacrimal nerve, external nasal nerve, infratrochlear nerve, infraorbital nerve, supraorbital nerve, or internal nasal nerve leading to inhibition of rhinitis like symptoms by overstimulation and/or relief from nasal congestion, migraines, narcolepsy, dry mouth, dry eye, and elevated intra-ocular pressure via neuromodulation. Focused, or directed vibration, be it sound in which the vibrating waves are directed toward the skin and bone by way of positioning the probe toward the nasopalatine ganglia, external nasal nerves, or eyelids, or lacrimal nerves have been determined to be more effective in eliciting specific pathways such as lacrimation.

FIG. 5 depicts a device usable to activate the lacrimation pathway by applying vibration to the side of the nose and/or lacrimal pathway to activate the external nasal nerve as it exits the nasal bone onto the skin of the nose. Vibratory energy at 100-300 Hz with 1 mm excursion and 1-4N of force stimulates the external nasal nerve when the energy is applied to the region with a sufficiently rigid biocompatible material.

In another preferred embodiment, the vibration is applied directly to the conjunctival region of the eyelid to stimulate tears directly by stimulating the accessory lacrimal glands in the lower lid and the small muscles that surround each of the Meibomian glands.

In one embodiment, the end effector of device 2000 is applied directly to the lacrimal gland 2100 or to the mucosa of the inner eyelid. Device 2000 is configured in one embodiment to run along the inner eyelid while the eyelid is being retracted to create tears, stimulate Meibomian glands, etc.

Therefore, in one embodiment, a vibratory device is applied to the skin/mucosa of the inner eyelid, applying an end effector moving at about 50-300 Hz with the end effector moving approximately 250 microns to 2 mm in excursion with 0.5 to 2N of force, the end effector having a biocompatible material with durometer between about 60 A and 100 A and a tip which applies the force to the skin over an area of about 1 mm² to 5 mm². Pulsed frequencies (on-off) can enhance the effect. For example, the vibration can be applied with a 50% duty cycle or a 25% duty cycle with a peak amplitude greater than the base amplitude. In one embodiment, device 2000 is depressed against the skin of the nose in the region where the nasal cartilage meets the nasal bone (aka the nasal ala) 2012 where the cartilage and nasal bone meet along the side of the nose of the patient at the region where the external nasal nerve exits the nasal bone.

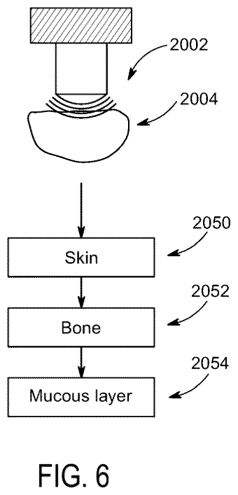

FIG. 6 depicts the structural details of the ultrasound transmission from the skin through the bone and to the nerves which lie beneath the bones of the face. The end effector 2004 of the device 2002 communicates with the skin 2050 and from there, the vibrations travel through the skin 2050 to the bone 2052 and to the mucous layer 2054 underneath. From the bone, the vibration can be transmitted to the nerves in other regions of the face such as the sphenopalatine ganglia, the infraorbital nerve, the orbital nerve, the facial nerve, the trigeminal nerve, the ethmoidal nerve, and ultimately, the lacrimal nerve.

Direct stimulation of the mucous layer through bone also will accomplish direct treatment of sinus disease in addition to its effect on the nerves. Vibration and/or ultrasound stimulation of the mucosal layers will affect congestion directly by unplugging the outflow pathways and equalizing pressure.

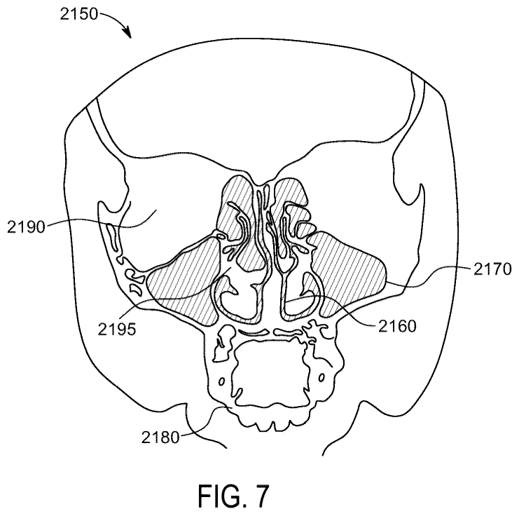

FIG. 7 depicts several of the bony pathways which can communicate with nerve pathways via neuroacoustic conduction present inside the cranium 2150 and facial bones. The maxillary sinus and bone 2170 are the predominant pathway for transmission of vibratory energy to the sphenopalatine ganglia and ultimately the lacrimal nerve and gland. The conchae 2195 are folds of the maxillary bone which protrude partially into the nasal cavity. The conchae protect the olfactory bulb as well as the sphenopalatine ganglia but also play a role in transmission of sounds. The maxillary bone and its conchae communicate with the zygomatic bone 2190. The inferior turbinates 2160 are covered with respiratory mucosa. The sphenopalatine ganglia sits behind the inferior turbinates. The mandible 2180 represents an additional, albeit less direct pathway, for stimulation of the nerves of the facial region. In a preferred embodiment, a resonant frequency for these bones is utilized in order to transmit vibrational energy to the nerves within or below the bone to achieve a clinical end such as generating tears in the eye, stopping cluster headaches, migraines, seizures, rhinitis, and nasal congestion.

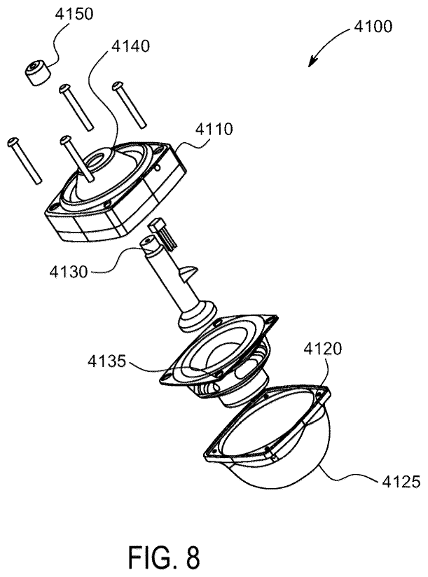

FIG. 8 depicts the expanded components of one embodiment of a device 4100 to stimulate tears. Item 4120 is the housing with an advanced user interface to allow for gripping the device and then applying to the external nasal nerve of a patient. Grip 4125 is a user interface for the device which contacts the palm of the user to allow for manipulation of the device while the biocompatible tip 4150 is manipulated and applied to the skin of the patient. The material is biocompatible and firm. Speaker or voice coil 4135 is the heart of the system, allowing for a continuous spectrum of frequencies, from 50 Hz all the way to kHz frequency as well as modulation of driving amplitude. Skin interface 4150 is stabilized by frame 4110. Frame 4110 also enables finger grips for further manipulation of the device. The skin interface 4150 is a biocompatible skin interface which allows for the application of cyclic force to the external nasal nerve, compressing the nerve against the nasal bone at a frequency of approximately 175 Hz to stimulate the nerve to generate tears. Shaft 4130 underneath the end effector is driven by the speaker to then drive the end effector element 4150. Interface 4140 provides the transduction interface between the speaker 4135 and the end effector 4150.

FIG. 9 depicts nasal anatomy. The frontal bone 5150 forms the upper boundary of the orbit and maxillary bone 5205 forms the medial boundary of the orbit. The frontal bone forms the roof of the frontal sinus. Maxillary bone forms the roof of the maxillary sinus 5260. The nares 5310 is the communication between the outside and the internal mucosa of the nose. The external nasal nerve 5215 leaves the nasal cavity through an orifice 5215 between the nasal bone 5200 and the lateral processes of the septal nasal cartilage 5210. It has been discovered that stimulation of the external nasal nerve in this region 5215 with force between 1-4N using vibration at 100-300 Hz results in several clinical effects including creation of tears, abrogation of allergic and vasomotor rhinitis, relief from sinusitis, stimulation of meibomian glands, treatment of headaches, and narcolepsy. Stimulation in the region 5100, 5290, 5300, 5310, 5230, 5250, 5280, 5300 in some patients have the same effect as stimulation of the external nasal nerve. Region 5300 is the region underneath the skin of the upper lip. i.e. direct mucosa contact above the gum line of the teeth.

FIG. 10 depicts the cutaneous nervous anatomy 5000 in and around the nasal cavity. Cutaneous, or subcutaneous, generally refers to nerves covered by skin, dead stratified squamous, keratinized epithelial cells. In contrast, mucosa or sub-mucosal, nerves are covered by non-keratinized mucosal epithelial cells which are generally ciliated and columnar. Cutaneous nerves are more difficult to reach with certain energy forms (e.g. electrical stimulation) because the dead stratified layers broadly diffuse the current. However, vibratory stimulation can be directed to the nerves underlying the skin by transmission of pressure waves. The external branch of the anterior ethmoidal nerve 5020, also referred to as the external nasal nerve, exits at the caudal portion of the nasal bone and supplies the ipsilateral side of the nose with cutaneous nerve fibers. Infraorbital nerve 5010 supplies cutaneous fibers to the lower eyelid, upper lip, and a portion of the nasal vestibule; the vestibule is the most anterior part of the nose, lined by the same epithelium as the skin. Its epithelium transitions to the respiratory epithelium of the nasal cavity proper. The infra-trochlear nerve 5035 supplies the skin of the upper eyelids, bridge of the nose, the conjunctiva, lacrimal sac, and the caruncle (small, pink, globular nodule at the inner corner of the eye made of skin covering the sebaceous and sweat glands). The supratrochlear nerve 5030 supplies the skin of the lower forehead, the conjunctiva and the skin of the upper eyelid. It has been discovered through experimentation described herein that vibratory stimuli (e.g. 50 Hz to approximately 300 Hz) of these nerves and nerve endings stimulate the lacrimal nerve to secrete tears and the meibomian glands to secrete oils and lipid. In these embodiments, the vibratory stimuli contact the stratified epithelium of the skin not the mucosa, and energy is transferred by mechanical waves. In some patients, the mechanical stimuli is effective along the dermatomes of the skin in an around the external nasal nerve. For example, in some patients, tear stimulation is possible by applying vibratory stimulation at approximately 150-300 Hz with the patient interface as specifically designed herein along the tip of the nose, along the upper lip, along the skin of the lower eyelid, etc. In these patients, tolerance to the treatment can in some cases be completely avoided by applying the treatment to different dermatomes for each application.

In one embodiment, the lacrimal gland is activated by stimulating the infraorbital nerve, the infra-trochlear nerve, the supratrochlear nerve, the caruncle, or the conjunctiva inside the eyelids. Indeed, the conjunctiva inside the eyelids or on the surface of the eye is mucosa and the upper layers are non-keratinized. Stimulation of these tissues is optionally performed with vibratory energy including sound, ultrasound, mechanical vibration, electrical sparking, puff of air, puff or water or other liquid, or other mechanically sharp stimulation impulse. In the mucosal tissues, electrical stimulation is also more possible because of the lack of stratified epidermis diffusing the current. Therefore, in one embodiment, energy is passed through the conjunctiva of the eye to stimulate tears.

FIG. 11 depicts a handheld embodiment of a device 5500 to apply vibrational energy to the facial region in which there is an underlying parasympathetic nerve or a circuit which ultimately results in stimulation of a parasympathetic nerve. Interface 5510 moves with linear excursion substantially perpendicular to the housing 5520. Housing 5520 is configured to be handheld and self-contained, produced from a comfortable, biocompatible plastic or aluminum material. Interface 5510 is fairly rigid with a rounded yet firm tip. The radius of curvature of the tip is such that it can firmly push into the junction of the nasal cartilage and nasal bone, vibrate a 100-300 Hz, preferably between 180 and 220 Hz or at least between 75 Hz and 300 Hz with maintenance of a constant speed despite the force being applied by the user to the nerve.

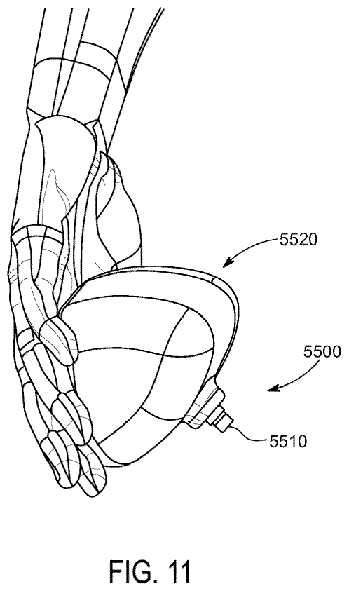

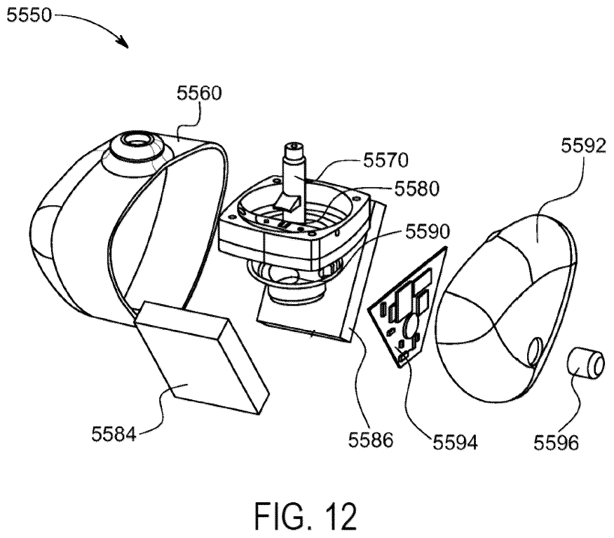

FIG. 12 depicts a detailed view 5550 of the handheld device in FIG. 11. The basic mechanism of this device is a voice coil 5590 which provides for a linear driving motion of the tip 5570. Plastic body 5560, 5592 surrounds the device. An optical distance sensor 5580 is calibrated to detect movement of the linear vibrating component 5570. Printed circuit board assembly 5594 comprises an amplifier and battery charging circuitry as well as an optional control system so that the tip 5570 vibrates at a near constant frequency. Power button 5596 and cover 5592 as well as lithium ion batteries 5584 and 5586 complete the unit. This unit is self-contained, and the lithium ion batteries are rechargeable.

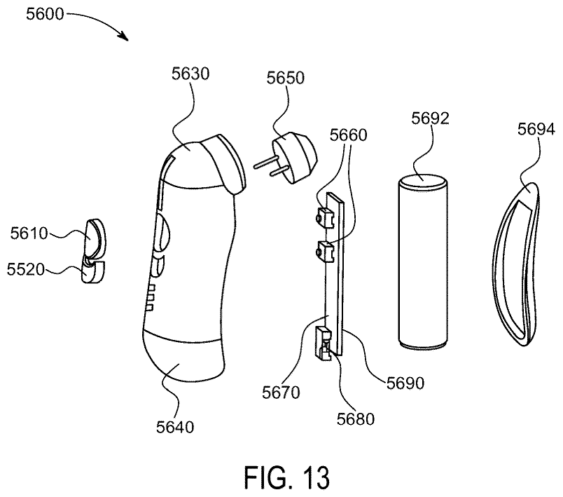

FIG. 13 depicts the components of a vibratory device 5600 which is configured to be held in the palm of the hand of the user with an interface 5610, 5620 with the tip of a finger of a user. Body surface interface 5650 is configured to be handheld and comfort grip 5694 is configured from a biocompatible material. Lithium ion 5692 battery is inserted into the main body housing 5630 (top) 5640 (bottom). Linear vibration motor 5650 travels with linear motion and is connected to the body surface interface to create linear motion as well. The surface interface is applied to the skin with perpendicular application to the skin to stimulate the external nasal nerve and the parasympathetic nervous system to open Meibomian glands, create secretions of oils, and produce tears from the lacrimal glands, treat migraines, epilepsy, narcolepsy, headaches, open blood brain barrier, equalize pressure, treat rhinitis and sinusitis, and nasal polyps. Tactile switches 5660, 5680 enable user guided feedback to increase or decrease stimulation level, either by signaling adjustment of the vibration amplitude and/or frequency. Structures 5670 and 5690 house the tactile sensors and transmits the signals to the use.

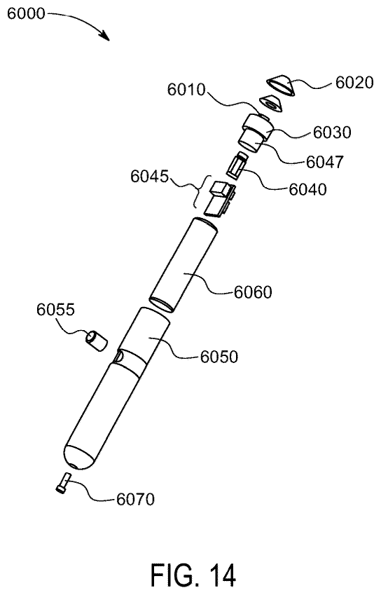

FIG. 14 depicts another embodiment of a device 6000 configured to apply vibrational energy to a nerve overlying a parasympathetic nerve of the face. Interface 6020 is a biocompatible skin interface designed to transfer force from the vibratory element to the skin overlying the bone of the patient and to the nerve underlying the bone. A snap element 6010 allows for quick placement and removal of the skin interface 6020. The vibration is generated by eccentric motor 6040 which vibrates the biocompatible interface with an approximately planar and perpendicular vibratory direction to the long axis of the device 6000. Contacting motor 6040 are components 6030, 6047 which are intermediate between the motor 6040 and the skin interface 6020. In some embodiments, these components are flexible or rigid which determines the flexibility or rigidity of the skin interface. In some embodiments, these components are even adjustable to create flexible patient interfaces. Switch 6055 powers the device on and off. Rechargeable battery 6060 and electrical access port 6070 enable power delivery to the device 6000. Additional electronics 6045 may include a lockout timer so that a user does not over use the device. A control system to maintain a pre-specified motor and vibration speed is also an optional feature of the circuitry. The electronics are housed in shell 6050.

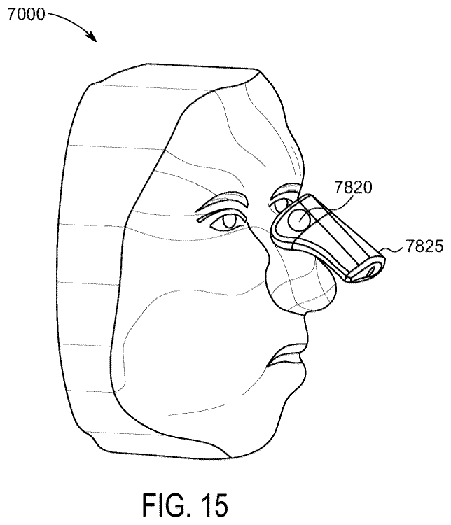

FIG. 15 depicts a device 7000 which can be applied bilaterally to the nose of a patient to stimulate the external nasal nerve simultaneously or individually depending on patient preference. A feature of this device is that it has haptic feedback 7825 such that as the patient presses down on the device switch 7820 and on the nose, the device responds by applying a greater force or displacement to ensure nerve stimulation. In other embodiments of FIG. 15, device 7000 functions as a strip that is applied bilaterally to the nose of a patient such that each end of the strip contacts the region on the left and right side of the nose where the nasal bone meets the anterior lateral nasal cartilage where the external nasal nerve is located.

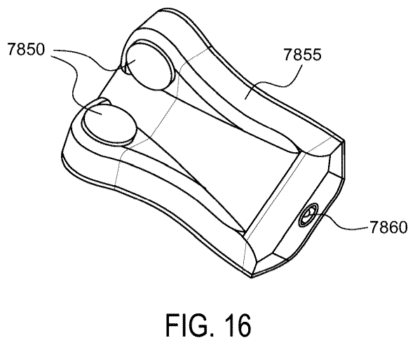

FIG. 16 depicts the underside of the device shown in FIG. 15. Pressure sensors 7850 sense the force being applied by the user. Material 7855 is preferably flexible so that the user can squeeze the device and compress the external nasal nerve and apply increasing vibrational force, the degree of which is dictated by the force the pressure sensor senses on the skin. The device is rechargeable via port 7860 which can also potentially serve as a data port.

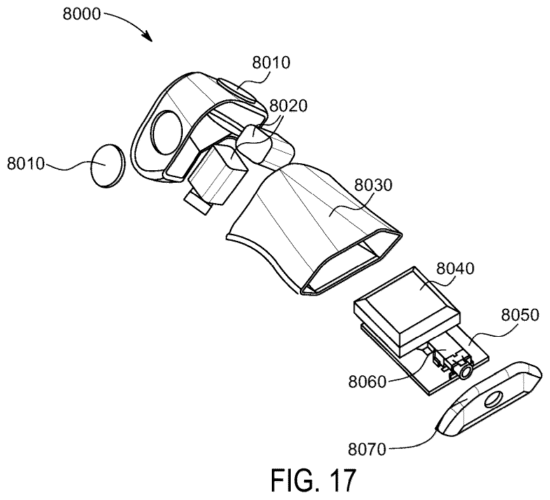

FIG. 17 depicts a schematic of the individual components of the device 8000 shown in FIG. 15. Pressure sensors 8010 enable coupling between the force applied by the user and the speed, torque, and force of the eccentric motors 8020 which create the vibratory effect to stimulate the external nasal nerve and parasympathetic pathway. Element 8030 is a housing for electronics and for the patient to grip while applying the vibration to the external nasal nerve and parasympathetic pathway. Battery 8040 is preferably rechargeable but also may be a replaceable battery. Cover 8070 seals the electronic circuit board 8050 and charge port 8060.

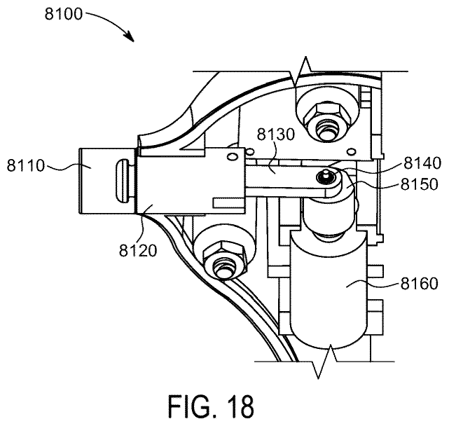

FIG. 18 depicts an embodiment 8100 in which the end effector interface 8110 moves in a linear direction, actuated by a cam 8150 mechanically connected 8140 to an electric motor 8160. Rotation of the motor linked to the cam 8150 drives a piston 8120 with an end 8110 which also serves as the biocompatible interface with an edge adapted to activate a nerve such as the external nasal nerve. The piston 8120 and biocompatible interface 8110 move at an optimal frequency between 100 and 300 Hz or between 50 Hz and 400 Hz. The cam 8150 can be offset from the central axis 8140 to determine the excursion of the piston (e.g. 1 mm) and interface which then applies force to the skin of the patient and then to the nerve to be stimulated. In some embodiments, a governor is included to ensure that the frequency that is set by the user or pre-determined before delivery to the user is the actual frequency of the piston excursion. For example, in one embodiment, a photodiode or other detector is utilized to detect motion of the electric motor, linkages, or the piston; if the revolutions per minute (RPM) are not as pre-specified, additional current is added or subtracted from the motor. Electronic circuitry is also included which enables the device to record the time of treatment, time between treatments as well as a lock out time in between treatments (e.g. to ensure that the device is not overused or underused). Such data is stored in memory and is downloadable offline to a PC as a record of usage and compliance with the device in real world practice or in a clinical trial setting. The circuit further controls the voltage to ensure a constant power to the motor and constant rotation which can be pre-set or varied by the user.

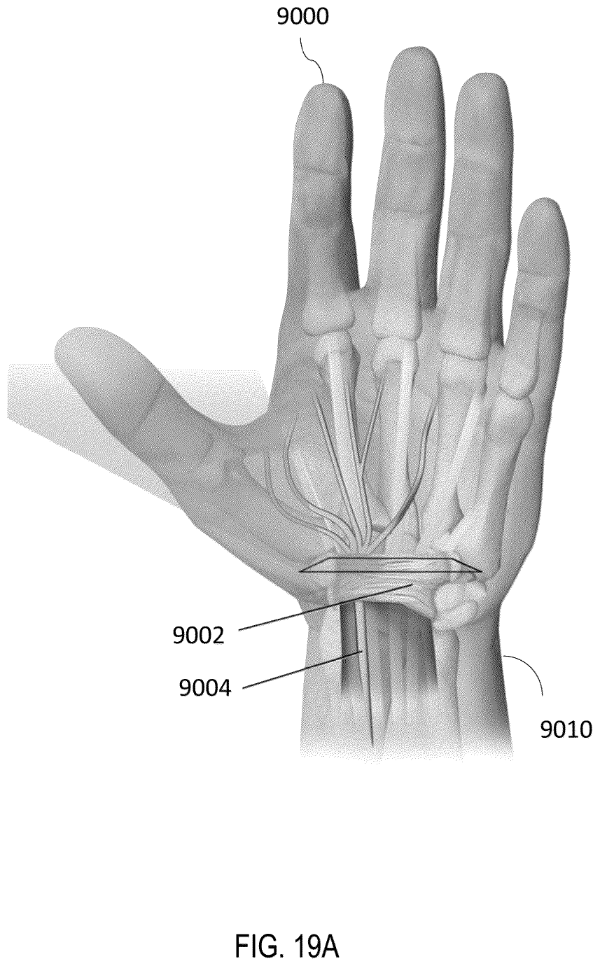

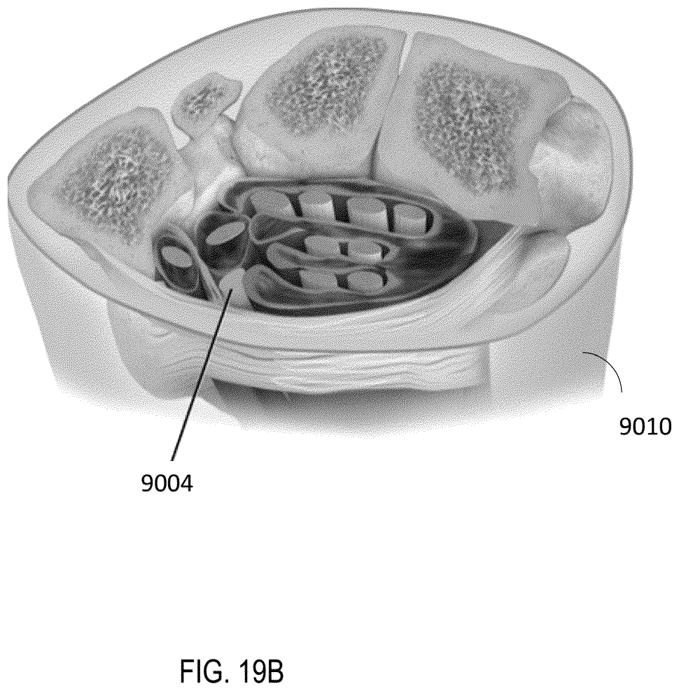

FIGS. 19A-19B depict a carpal ligament 9002 and median nerve 9004 of a hand 9000 and wrist 9010 of an individual. Carpal Tunnel Syndrome (CTS) is a medical condition due to compression of the median nerve 9004 as it travels through the wrist 9010 at the carpal tunnel. The main symptoms are pain, numbness, and tingling, in the thumb, index finger, middle finger, and the thumb side of the ring fingers. In some embodiments, the devices and methods described herein may be used to stimulate or decompress the median nerve 9004 as it travels through the wrist 9010, for example by providing external ultrasound and/or mechanical vibration to a region adjacent to or on top of the median nerve 9004.

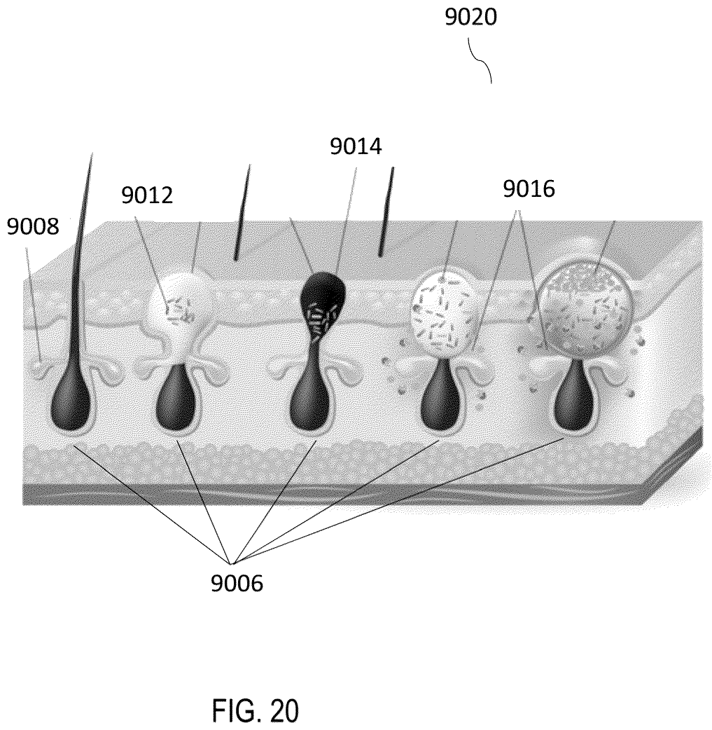

FIG. 20 depicts various mechanisms through which a pore on a skin surface 9020 becomes plugged. A skin surface 9020 includes numerous pores 9006, and these pores 9006 can become plugged for any variety of reasons, for example overactive sebaceous glands 9008, bacteria 9012, deadline skin cells 9014, and inflammation 9016, among other mechanisms. In some embodiments, the devices and methods described herein may be used to disrupt the causative agent of the plugged pore, for example by providing external ultrasound and/or mechanical vibration to a region adjacent to or on top of the pore.

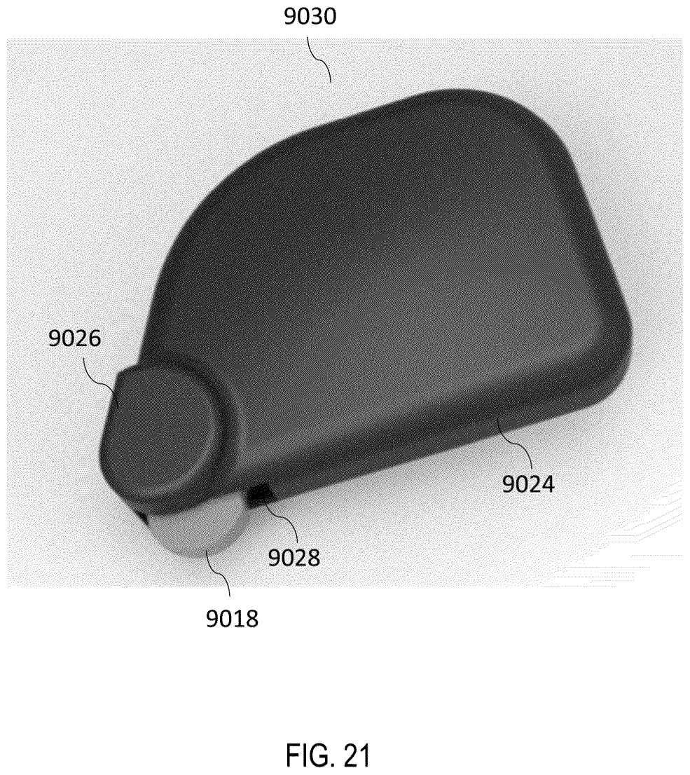

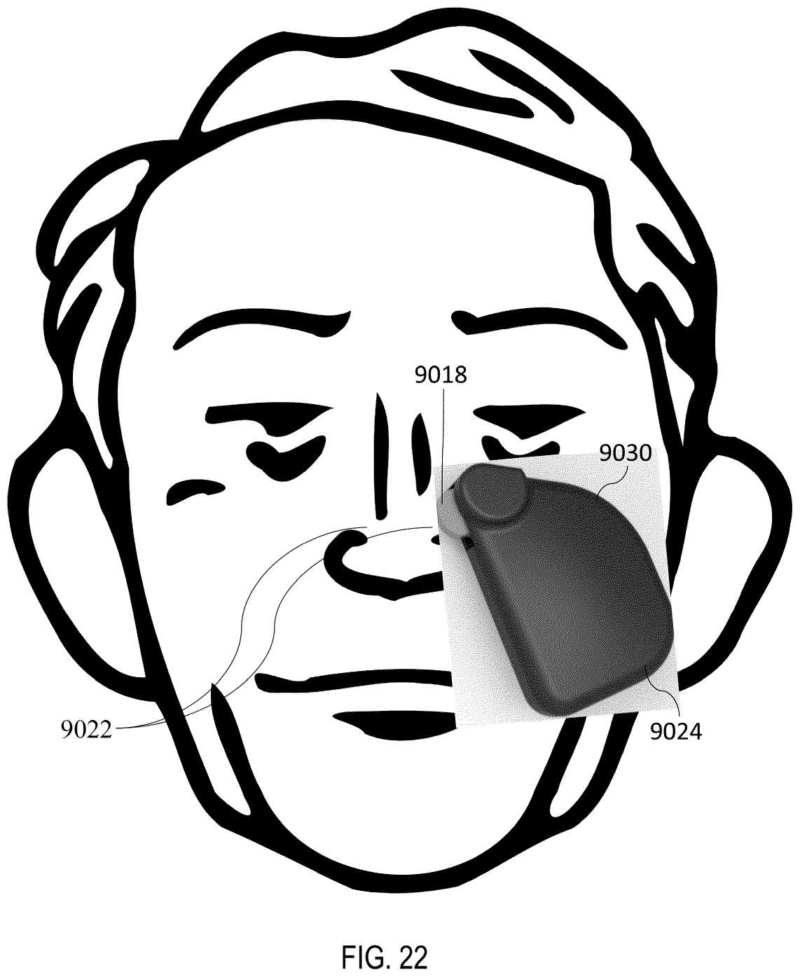

Turning to FIG. 21. FIG. 21 depicts another embodiment of a device 9030 which generates substantially one-dimensional vibratory or oscillatory motion to be applied to the skin or eye structure of a patient, as described elsewhere herein. Device 9030 uses effector tip 9018 to provide mechanical vibration to a skin surface or eye structure to stimulate a nerve (e.g., external nasal nerve, median nerve, etc.), inhibit a nerve, treat a skin condition, induce tear production, clear congestion, treat sinusitis, or any other condition known in the art and/or described elsewhere herein. For example, as shown in FIG. 22, oscillation of effector tip 9018 of device 9030 is applied to the junction of the nasal bone and the anterior lateral nasal cartilage where the external nasal nerve 9022 is located. In some embodiments, effector tip 9018 of device 9030 is applied to the external nasal nerve to treat, for example, congestion or sinusitis.

In some embodiments, device 9030 is incorporated into a phone case, for example insertable into a pocket of a case or attachable to a case.

In some embodiments, device 9030 is associated with an application configured to run on another user device, for example a mobile device, smart watch, or computer, to track, monitor, and/or modulate device 9030 performance.

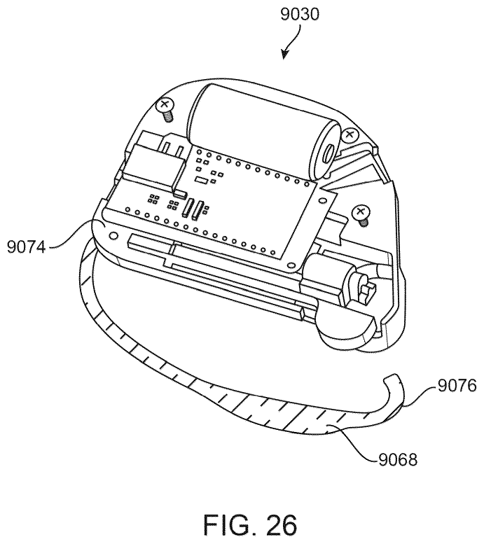

In some embodiments, as shown in FIGS. 21-22, device 9030 includes housing 9024. Housing 9024 functions to at least partially encapsulate or house one or more components of device 9030. For example, effector tip 9018 is partially housed within housing 9024 but also protrudes or extends from housing 9024 via aperture 9028 defined by one or more sidewalls of housing 9024. Alternatively, in some embodiments, device 9030 does not include a housing, but rather includes a plate or surface (e.g., flat or irregular) to which one or more components of device 9030 are coupled, attached, adhered, or otherwise fastened. Further, the housing 9024 of some embodiments includes or is formed of two or more halves or pieces such that the two or more halves or pieces are coupled, attached, bonded, adhered, or otherwise fastened together. The two or more halves may be reversibly coupled or irreversibly coupled. In other embodiments, housing 9024 is formed of a monolithic piece or structure (i.e., consisting of one piece). Housing 9024 includes or is formed of a plastic, for example polyamide, polycarbonate, polyester, polyethylene, polypropylene, polystyrene, polyurethane, polyvinyl chloride, polyvinylidene chloride, acrylonitrile butadiene styrene, or any other plastic or material known in the art. In some embodiments, as shown in FIG. 21, housing 9024 includes a beveled or contoured region 9026 to accommodate effector tip 9018. Contoured region 9026 may be sized and shaped similar to effector tip 9018, for example substantially circular in shape or partially circular in shape (e.g., semi-circular). In some embodiments, device 9030 further includes retractor 9068, as shown in FIG. 26. Retractor 9068 functions to retract an eye lid or another body portion or structure of a user so that ultrasound and/or vibration can be applied to a surface of the lid, eye, or an eye structure in or around the eye of the user. A first end 9074 of retractor 9068 may be movably coupled to housing 9024, for example via a hinge, joint, or pivot point. In other embodiments, retractor 9068 is coupled to a plate or other surface to which components of device 9030 are coupled. A second end 9076 of retractor may have a curved shaped with an atraumatic surface for contacting and retracting an eye lid or other body portion or structure of the user.

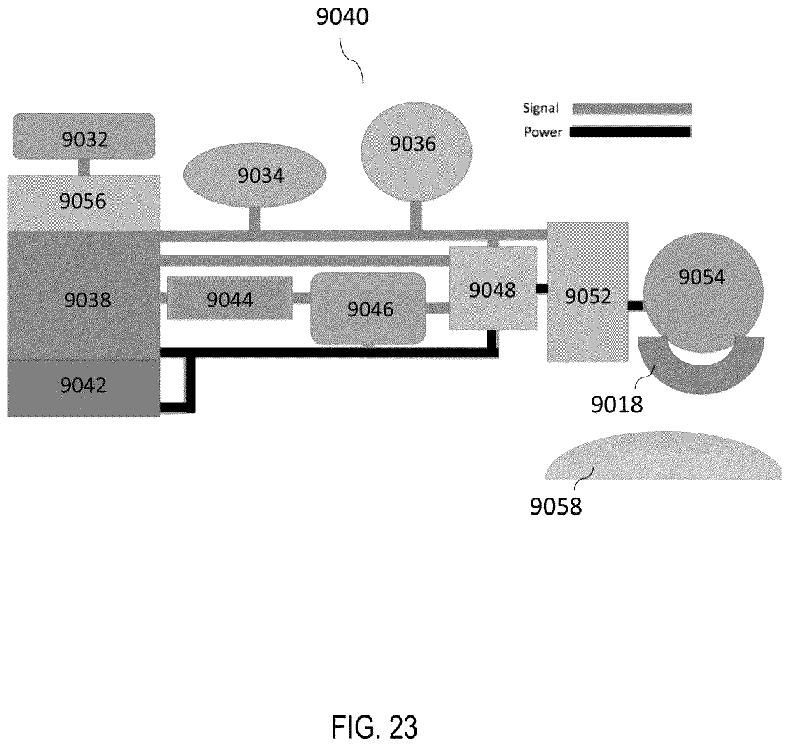

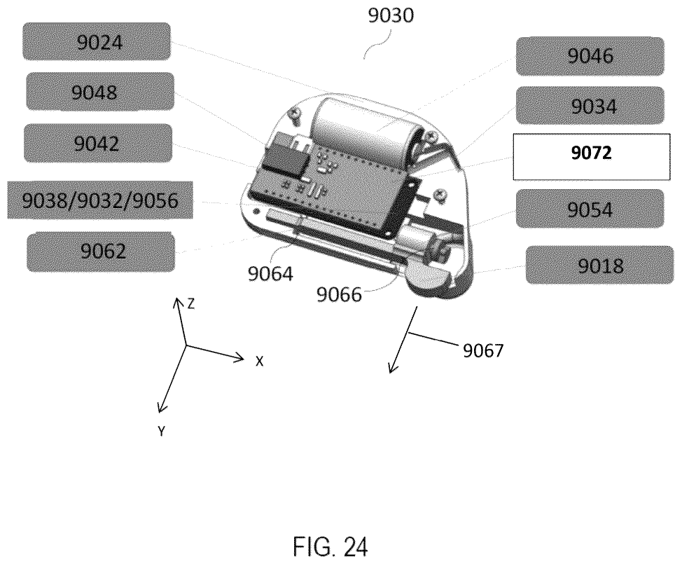

Turning now to FIGS. 23-24. FIG. 23 is a schematic representation of one embodiment of device 9030 of FIG. 21, and FIG. 24 depicts a cross-sectional view of one embodiment of the device of FIG. 21. FIGS. 23-24 shows various components 9040 of device 9030. For example, one or more components of device 9030 may include: memory or storage medium 9032, a power switch 9034, a charge indicator 9036, a controller 9038, a power source charging port 9042, a battery voltage detector 9044, a power source 9046, a direct current (DC)-to-DC converter 9048, a driver 9052, a motor 9054, I/O device 9056 (e.g., non-volatile medium reader/writer), circuit board 9072, effector tip 9018, and cantilever beam 9062. Each component will be described in detail with reference to FIGS. 23-24.

One or more components 9040 described herein are mounted to circuit board 9072, for example a printed circuit board, and electrically interconnected via the circuit board 9072, as shown in FIG. 24.

In some embodiments, as shown in FIGS. 23-24, device 9030 includes storage medium 9032 (e.g., SD card). Storage medium 9032 includes one or more of RAM, ROM, flash memory, EEPROM, a hard disk drive, a solid-state drive, or any other suitable device. In some embodiments, data is stored in non-volatile memory on storage medium 9032; in other embodiments, data is stored in volatile memory on storage medium 9032. Storage medium 9032 stores data, for example use data, battery voltage data, DC-to-DC converter data, etc. In some embodiments, storage medium 9032 is removable from device 9030 to extract and/or analyze use data; in other embodiments, storage medium 9032 is not accessible but rather data is removed from the storage medium through a port (e.g., IEEE 1934, thunderbolt, lightning, etc.) on the device 9030. Data is written to and from storage medium 9032 via I/O device 9056. For example, the I/O device 9056 of some embodiments may be an SD reader/writer.

In some embodiments, as shown in FIGS. 23-24, device 9030 includes power switch 9034 accessible by a user on an exterior of housing 9024 of device 9030. Power switch 9034 activates or deactivates device 9030. Power switch 9034 may be a button, toggle switch, or any other switch known in the art. When power switch 9034 is selected by a user to activate device 9030, driver 9052 (e.g., MOSFET driver) is activated to drive motor 9054 (e.g., eccentric motor) which oscillates cantilever beam 9062 and effector tip 9018, as described in further detail elsewhere herein.

In some embodiments, as shown in FIGS. 23-24, device 9030 includes a power source 9046. In some embodiments, power source 9046 is a rechargeable battery (e.g., Lithium ion battery); in other embodiments, power source 9046 is a disposable battery. In some such embodiments, for example, the device 9030 may be disposed of once the power source 9046 is depleted. Power source 9046 is configured to hold a charge for an extended period of time, for example greater than 1 week, 2 weeks, 3 weeks, or any range or subrange therebetween. During extended periods of non-use, power source 9046 enters into a low power mode, such that the current drops to the nanoamperes (nA) range, for example substantially 200 nA. In some embodiments, device 9030 enters a “deep sleep” mode during extended periods of non-use. Such modes are interrupted by activation or toggling of the power switch 9034. In some embodiments, power source 9046 is configured to maintain a small percentage of charge, for example 5%, 10%, 15%, or 20%, or to not drain power below a certain percentage or threshold so that data may be removed from storage medium 9032 and/or charge indicator 9036 may be illuminated to indicate an energy deficient, power required state of device 9030. In such states, the device 9030 does not function to provide a treatment session to protect a user from an incomplete or inefficient treatment session, for example due to insufficient voltage supplied to the motor.

In some embodiments, as shown in FIGS. 23-24, device 9030 includes a power source charger 9042. Power source charger 9042 is a port for receiving an adapter therein to charge or supply power to power source 9046. In some embodiments, power source charger 9042 is a USB port; in other embodiments, power source charge 9042 is an IEEE 1934, thunderbolt, lightning, etc. port. Alternatively, in some variations, power source charger 9046 is an inductive charging surface or a solar panel.

In some embodiments, as shown in FIGS. 23-24, device 9030 includes a charge indicator 9036 visible on an exterior of housing 9024 of device 9030. Charge indicator 9036 indicates whether device 9030 has sufficient charge to operate device 9030 or whether charging is required before a subsequent treatment cycle. In some embodiments, charge indicator 9036 is a light-emitting diode (LED) or a series of LEDs; in other embodiments, charge indicator 9036 is another type of light-emitting device (e.g., OLED) or color indicator. For example, charge indicator 9036 may fluoresce green or emit a green colored light when power source 9046 is fully charged and yellow, orange, or red when power source 9046 requires power input or recharging. In some embodiments, charge indicator 9036 includes a series of indicators such that in a fully charged state, all indicators are illuminated and/or a pre-determined color, and as charge is used, fewer indicators are illuminated and/or the indicators change color. In some embodiments, as shown in FIGS. 23-24, the controller 9038 and I/O device 9056 are coupled, via one or more buses, to the storage medium 9032 in order to read information from, and write information to, the storage medium 9032. For example, controller 9038 receives information from one or more of: charge indicator 9036, driver 9052, DC-to-DC converter 9048, power source 9046, battery voltage detector 9044, power source charger 9042, power switch 9034, storage medium 9032, I/O device 9056, and/or any other component. In some embodiments, controller 9038 receives a treatment start time, a power source voltage when motor 9054 is in an off state; a power source voltage when motor 9054 is in an on state; a DC-to-DC converter voltage; a treatment top time; a number of treatment sessions; a treatment duration (e.g., instant, previous, average, median, etc.); or any other relevant information for any one or more of components 9040.

In some variations, device 9030 includes a search mode. For example, a search mode may include one or more presets, each representing a different frequency of effector tip oscillation. Once search mode is activated, for example by a user depressing the effector tip for a pre-determined period of time or selecting a user input element, device 9030 may cycle through each of the pre-sets to allow the user to determine which pre-set is the most effective for achieving the desired therapeutic response. In some embodiments, each pre-set has a slightly higher or lower frequency than the preceding pre-set. Alternatively or additionally, each pre-set has a slightly greater or lesser force than the preceding pre-set. Once the user has identified an ideal pre-set to achieve the desired therapeutic effect, the user selects the desired pre-set, for example by double pressing the effector tip when the device 9030 reaches the pre-set during the cycle, by selecting the pre-set using a user input element (e.g., button, switch, toggle, etc.), or by another method known in the art.

In some embodiments, device 9030 includes one or more intensity modes, for example ranging from soft to intermediate to intense. The user may select an intensity mode using a user input element (e.g., button, toggle, etc.) or, in some embodiments, device 9030 is preconfigured with an intensity based on the desired clinical application.

In some embodiments, device 9030 includes a pressure sensitive switch or a power switch 9034 of device 9030 is a pressure sensitive switch. For example, the pressure sensitive switch senses a continuum of force when pressed lightly to more firmly; this output can then be used to modulate the device's vibratory frequency, amplitude, or both. In some embodiments, multiple switch presses vary an output frequency of device 9030. In some embodiments, multiple switch presses vary an output amplitude of device 9030.

In some embodiments, device 9030 is disposable. For example, a number of treatments (e.g., 100, 200, 300, 400, 500, less than 500, more than 500 treatments, or any range or subrange there between) performed by device 9030 may be read by controller 9038 of the device 9030 and written to storage medium 9032, for example via I/O device 9056, such that the device becomes inactive or is in a permanent off state once a threshold number of treatments has been reached. In other embodiments, device 9030 is reusable. For example, a power source 9046 of device 9030 may be rechargeable and/or replaceable.

In some embodiments, as shown in FIGS. 23-24, device 9030 includes a battery voltage detector 9044. Battery voltage detector 9044 determines whether voltage coming from power source 9046 or power source charger 9042 is in a safe range (i.e., to prevent any current extremes), for example to protect a skin surface or eye of the user from effector tip frequencies or forces that may cause abrasions or ineffective treatment. In some embodiments, as shown in FIGS. 23-24, device 9030 includes a voltage converter 9048, for example a DC-to-DC converter (e.g., buck-boost converter). Voltage converter 9048 produces an output voltage magnitude that is either greater than or less than the input voltage magnitude. In some embodiments, revolutions per minute (RPM) of the motor 9054 and ultimately a frequency of effector tip 9018 oscillation is increased or decreased when a voltage supplied to the motor 9054 is increased or decreased, respectively. In such embodiments, a manufacturer, healthcare provider of the user, or user of device 9030 can set or control an intensity of effector tip 9018 oscillation by controlling the voltage output by the voltage converter 9048.

In some embodiments, as shown in FIGS. 23-24, device 9030 includes motor 9054. Motor 9054 functions to oscillate effector tip 9018 via, for example, beam 9062, as will be described in further detail elsewhere herein. In some embodiments, motor 9054 is an eccentric rotating mass (ERM) motor using an unbalanced weight or mass 9066 but may also be any other type of motor known in the art, for example a linear resonant actuator. The ERM is configured to cause the beam 9062 to vibrate (oscillate) while the beam 9062 is carrying the motor 9054. In particular, because the beam 9062 is carrying the motor 9054, rotation of the mass 9066 by the motor 9054 will cause the beam 9062 together with the motor 9054 to oscillate in a desired direction, for example perpendicular to a surface 9058 of tissue. In some embodiments, the motor 9054 may be configured to rotate the ERM at a certain frequency that maximizes a vibrational amplitude of the effector tip 9018. In other embodiments, the motor 9054 may be configured to rotate the ERM at other frequencies, which do not necessarily maximize a vibrational amplitude of the effector tip 9018. Also, in some embodiments, the motor 9054 is configured to rotate the mass 9066 at a frequency that corresponds with the natural frequency of the beam 9062 (with the mass of the motor 9054). For example, the motor 9054 may rotate the mass 9066 at a frequency that is equal to, or near the natural frequency fn of the beam 9062 (with the mass of the motor 9054)—e.g., fn±0.1 fn. In other embodiments, the motor 9054 may be configured to rotate the mass 9066 at other frequencies that may not correspond with the natural frequency of the beam 9062 (with the mass of the motor 9054). In some embodiments, device 9030 includes a modular motor that can be changed or altered by a user or prescribing health professional to better match a frequency or amplitude of device output to a user's needs.

In some embodiments, a majority of a length of the beam 9062 may have a cross section shaped with a certain orientation to ensure that the beam 9062 will undergoing bending action in a desired direction in response to the turning of the eccentric mass 9066 by the motor 9054. For example, the beam 9062 may have a rectangular cross section having a long side and a short side. The cross section may be oriented so that the long side of the rectangular cross section is perpendicular to a desired bending direction 9067 of the beam 9062 (e.g., is parallel to the Z-axis), and so that the short side is parallel to the desired bending direction (e.g., parallel to the Y-axis). This configuration orientates the beam 9062 so that its weaker bending stiffness is associated with bending action within the X-Y plane, and its stronger bending stiffness is associated with bending action within the X-Z plane. As a result, the beam 9062 is more easily bend within the X-Y plane than within the X-Z plane. In other embodiments, the beam 9062 may have other cross sectional shapes, such as an elliptical shape, a T-shape, or any of other shapes. Also, in some embodiments, a cross sectional moment of inertia of a cross section of the beam 9062 about the Z-axis is less than a cross sectional moment of inertia of the cross section of the beam 9062 about the Y-axis. This feature also provides an orientation of the beam 9062 so that its weaker bending stiffness is associated with bending action within the X-Y plane, and its stronger bending stiffness is associated with bending action within the X-Z plane. As a result the beam 9062 is more easily bend within the X-Y plane than within the X-Z plane. Also, in some embodiments, electrical wires from the motor 9054 may be attached to the beam 9062 to avoid any relative movement between the beam 9062 and the electrical wires. For example, the beam 9062 may have one or more openings or frames for allowing the electrical wires to extend therethrough, thereby allowing the beam 9062 to carry the electrical wires, and allowing the beam 9062 and the electrical wires to move (vibrate) together. In some embodiments, a majority of a length of the electrical wires, or portion(s) of the electrical wires, may be coupled to an external surface of the beam 9062. In other embodiments, a majority of a length of the electrical wires, or portion(s) of the electrical wires, may be coupled internally within the beam 9062. In other embodiments, the electrical wires from the motor 9054 may not be attached to the beam 9062.

In the illustrated embodiments, the motor 9054 is attached to the beam 9062 so that the motor 9054 and the beam 9062 can move (e.g., vibrate) together in response to the motor 9054 turning an eccentric rotating mass 9066 attached to a shaft of the motor 9054. This feature is advantageous because it allows the device 9030 to operate more quietly. In particular, because the motor 9054 is configured to cause the beam 9062 to vibrate together with the motor 9054 without using any mechanical linkage that moves and touches against the beam 9062, there is no noise generated from any moving part touching the beam 9062. Also, for this same reason, the chance of the beam 9062 having wear and tear and having mechanical failure is substantially reduced, and the device 9030 has a relatively longer lifetime (at least compared to the embodiment of FIG. 18 that uses a reciprocal motor 9054, or to a technique that involves the motor moving the beam via mechanical linkage that moves and touches the beam).

In other embodiments, instead of having the motor 9054 immovably attached to the beam 9062, the device 9030 may include a motor that is immovably attached to the housing or to a frame within the housing. In such cases, the motor 9054 is configured to move the beam 9062 in an oscillatory manner via mechanical linkage, and the beam 9062 is configured to move relative to the motor 9054.

In some embodiments, device 9030 may include two or more motors acting (e.g., causing vibration) on a beam. The two or more motors may be arranged orthogonally or at angles with respect to one another to provide vibratory control in multiple planes of motion.

In some embodiments, device 9030 includes two or more motors aligned in the same plane but spinning in opposite directions amplifying motion in a primary direction but canceling motion in a secondary lateral direction. In some embodiments, device 9030 includes two or motors acting on a beam to provide increased vibratory amplitude in a primary direction of motion.

In some embodiments, device 9030 includes a transmitter or transceiver, for example to communicate data to nearby devices including cell phones, computers, and smart watches.

In some embodiments, device 9030 is equipped with a biometric reader, for example a fingerprint or eye scanner or facial recognition software. Biometric reader may be configured to limit device 9030 use to one or more users.

In some embodiments, device 9030 includes electronics, software, and/or one or more parameters that limit device 9030 use to a prescribed number of treatments.

In some embodiments, device 9030 includes a display configured to display use data, a treatment duration, a treatment frequency, a treatment history, a prescribed treatment regimen, a frequency of vibration, an amplitude of vibration, etc. or to prompt a user to apply a treatment using device 9030.

In some embodiments, device 9030 includes a visual, auditory, and/or haptic modality for alerting a user that it is time to use device 9030 for a treatment session and/or that the prescribed duration of use has been achieved.

Turning now to effector tip 9018 and beam 9062. Effector tip 9018 functions as the treatment surface, for example for contacting a skin surface or an eye structure of a user. In some embodiments, effector tip 9018 includes or is formed of a plastic, for example acrylonitrile butadiene styrene, but may also be any other plastic or material known in the art. Effector tip 9018 is shaped and configured to have smooth contours to limit unintended abrasions during use but to elicit effective treatment. In some embodiments, a durometer of the effector tip 9018 is between 20 A to 80 A, 30 A to 70 A, 40 A to 60 A, 40 A to 50 A, 50 A to 60 A, 45 A to 55 A, or any range or subrange therebetween. The durometer of effector tip 9018 is configured to induce effective treatment while limiting unintended effects, such as abrasions.

In some embodiments, effector tip 9018 is replaceable and/or can be equipped with elastomers of varying stiffness to better meet the comfort needs of each user. In some embodiments, effector tip 9018 includes a conductive heating element, for example a resistive coil to heat tissue while in operation. In other embodiments, effector tip 9018 includes a radiative heating element, for example an infrared light to heat tissue while in operation. The radiative heating element of some embodiments radiates electromagnetic energy between 400-1000 nm wavelength at effector tip 9018. Effector tip 9018 is coupled to beam 9062 (e.g., two components coupled together or as a monolithic component) and oscillates as result of motor 9054 movement via contact with beam 9062 and effector tip 9018. The oscillation is dictated by a combination of the motor rotation and the weight and geometry of beam 9062 and the reactions at coupling element 9064. A stiff coupling element 9064 will result in a lower frequency whereas a loose coupling element 9064 will result in a higher frequency but also less force per revolution on a surface of the patient. The effector tip 9018 oscillates with a substantially fixed amplitude in air. For example, the substantially fixed amplitude is between about 0.1 and 2 mm, 0.2 mm and 1.8 mm, 0.25 mm and 2 mm, 0.25 mm and 1.5 mm, or any range or subrange therebetween. In some embodiments, the fixed amplitude is substantially 1 mm, greater than 0.1 mm, greater than 0.2 mm, less than 2 mm, less than 1.75 mm, less than 1.5 mm, or any value, range, or subrange therebetween.

The effector tip 9018 oscillates with a force, such force being related to a natural frequency of beam 9062 and a frequency of oscillation of motor 9054, as described in more detail elsewhere herein. In some embodiments, the effector tip oscillates with a force of substantially 0.5N to 5N, 1N to 3N, less than 5N, less than 4N, less than 3N, greater than 0.5N, greater than 0.75N, greater than 1N, or any value, range, or subrange therebetween.

The effector tip 9018 oscillates with a frequency, such frequency being related to a natural frequency of beam 9062 and a frequency of oscillation of motor 9054, as described in more detail elsewhere herein. In some embodiments, a frequency of oscillation of the effector tip 9018 is substantially 5 Hz to 500 Hz, 25 Hz to 400 Hz, 50 Hz to 300 Hz, 50 Hz to 250 Hz, greater than 25 Hz, greater than 50 Hz, less than 500 Hz, less than 300 Hz, less than 250 Hz, or any value, range, or subrange therebetween. In some embodiments, a frequency, force, and/or amplitude of effector tip 9018 oscillation is dampened by an amount of force a user applies to the device 9030 against a surface 9058; in other embodiments, a frequency or force of effector tip 9018 oscillation is maintained regardless of an amount of force a user applies to the effector tip 9018 against a surface 9058, for example as shown in FIG. 18. For example, a user of device 9030 controls an intensity of a treatment session by controlling an output force and/or frequency of oscillation of effector tip 9018. The beam 9062 bends when a force is applied to the effector tip 9018, such that bending beam 9062 slows motor 9054 and reduces effector tip 9018 oscillation. Such force and/or frequency of effector tip 9018 is controlled by the user applying force to the effector tip 9018 during a treatment session. For example, a frequency of oscillation of the effector tip 9018 is dampable when a force of substantially 0.5N, 0.6N, 0.7N, 0.8N, 0.9N, 1N, 1.1N, 1.2N, 1.3N, 1.4N, 1.5N, greater than 0.75N, greater than 0.8N, greater than 0.9N, less than 1.2N, less than 1.1N, or any force value in between is applied to effector tip 9018.

Correspondingly, the amplitude of oscillation of effector tip 9018 is dampable when a force of substantially 0.5N, 1N, 1.1N, 1.2N, 1.3N, 1.4N, 1.5N, 1.6N, 1.7N, 1.8N, 1.9N, 2N, 2.1N, 2.2N, 2.3N, 2.4N, 2.5N, greater than 1.5N, less than 2.5N, or any force value therebetween is applied to effector tip 9018. The dampable nature of effector tip 9018 is critical for the atraumatic use of device 9030. In embodiments where effector tip 9018 is not dampable, a user applying a greater force than is required for effective treatment may result in abrasions on the skin surface or eye structure because a frequency or amplitude of oscillation of effector tip 9018 would not adjust in response to the applied force.

In some embodiments, device 9030 includes a motion sensor, for example an accelerometer, gyroscope, inertial sensor, etc. to measure vibratory output that may be fed into the device's control loop.

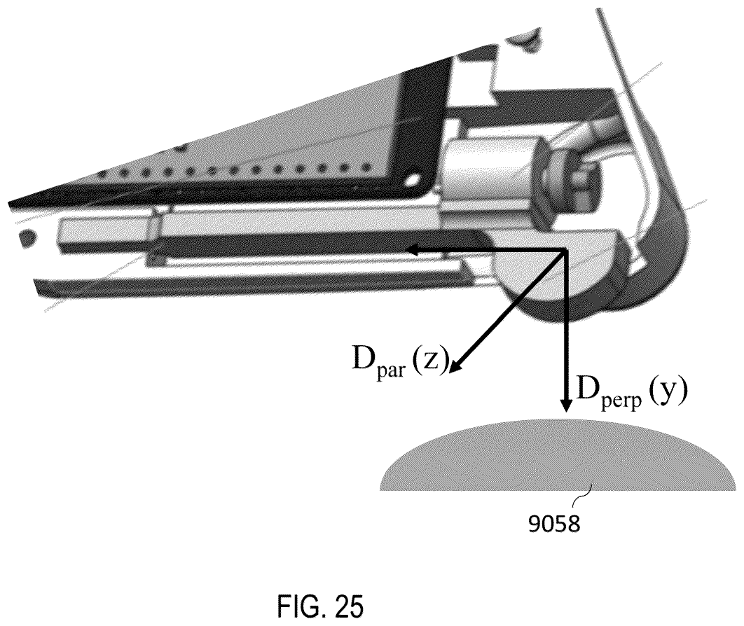

In some embodiments, as shown in FIG. 24, device 9030 includes beam 9062 coupled to effector tip 9018. Beam 9062 is coupled to device 9030 via a coupling element 9064 (e.g., a bracket, joint, fastener, pivot point, hinge, etc.). Coupling element 9064 couples beam 9062 to housing 9024 or to a plate or surface to which the components are coupled. Beam 9062 functions to maintain oscillation of effector tip 9018 in substantially one dimension, for example perpendicular to a surface. In some embodiments, there is additional motion parallel to the surface. The beam 9062 constrains oscillation of the motor into substantially one direction (i.e., perpendicular to surface Dₚₑᵣₚ in a direction y), as shown in FIG. 25, but, in some embodiments, there is also movement in a plane parallel to the surface Dₚₐᵣ in a direction z. In some embodiments, a ratio of movement parallel Dₚₐᵣ to the surface versus perpendicular Dₚₑᵣₚ to the surface is 1:2, 1:4, 1:8, 1:12, 1:16, or any ratio therebetween. For example, for every one movement parallel to the surface there are four movements perpendicular to the surface. In some embodiments, movement in one direction parallel to the surface is less than 1 mm; in other embodiments, movement in one direction parallel to the surface is substantially 1 mm, 1-1.5 mm, 1.5-2 mm, 2-2.5 mm, 2.5-3 mm, less than 5 mm, or any value, range, or subrange therebetween.

In some embodiments, device 9030 includes a modular beam that can be changed or altered by a user or prescribing health professional to better match a frequency or amplitude of device output to a user's needs.

In some embodiments, device 9030 includes two or more beams. In some embodiments, the two or more beams are oriented to simultaneously stimulate tear production in left and right eye, for example by stimulating the external nasal nerve on both the right and left side of a nose of a user.

Further, the geometry of the beam 9062 results in beam 9062 having a natural frequency at substantially 200 Hz (e.g., 200 Hz±20 Hz); the oscillation frequency of the motor 9054 is set to substantially the natural frequency of beam 9062 or the natural frequency of beam 9062 plus coupling element 9064, so that the beam 9062 and the motor 9054 work synergistically. In some embodiments, the dimensions of beam 9062 are 4 mm wide, 3 mm deep and 50 mm in length. In other embodiments, the dimensions of beam 9062 range from 2-8 mm wide, 1-6 mm deep, and 25-75 mm in length, or any range or subrange therebetween. For example, since beam 9062 is substantially constrained to rotation in a plane, it is sufficient to consider its moment of inertia about an axis perpendicular to the plane. The following equation (1) may be used:

$$I = {bd}^{3} / 12 \qquad ( 1 )$$

where I is the moment of inertia (angular mass or rotational inertia),
b is the width of beam 9062, and
d is the depth of beam 9062.

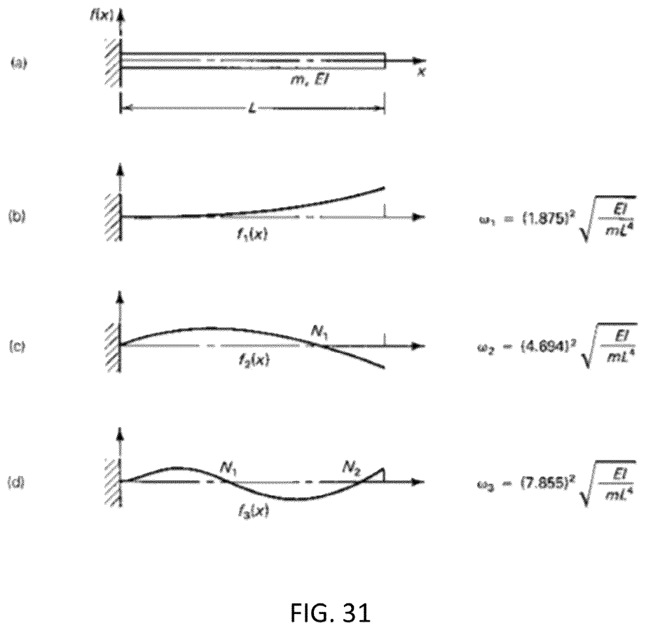

A natural frequency of beam 9062 is calculated, for example, according to the equations (a) through (d) in FIG. 31, in which:
m is a mass per unit length of the beam 9062,
L is the distance from the fixed end of beam 9062,
E is the modulus of rigidity of the material of beam 9062,
I is the moment of inertia (calculated in (1)) of beam 9062,
ω is the natural frequency (ω₁, ω₂, ω₃; first, second, third natural frequency, respectively) of beam 9062,
f(x) is displacement in y direction at distance x from fixed end of beam 9062, and 1.875, 4.694, and 7.855 are constants &n.

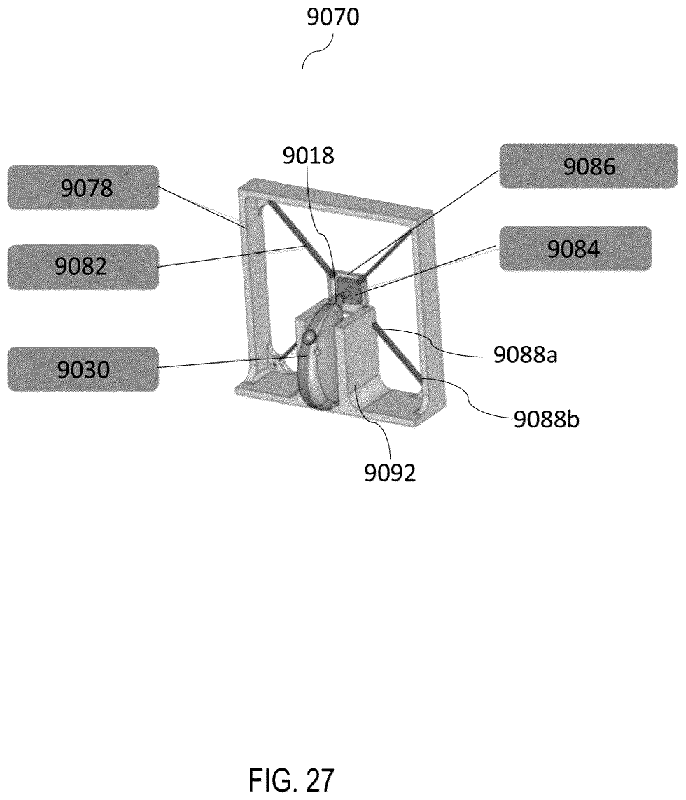

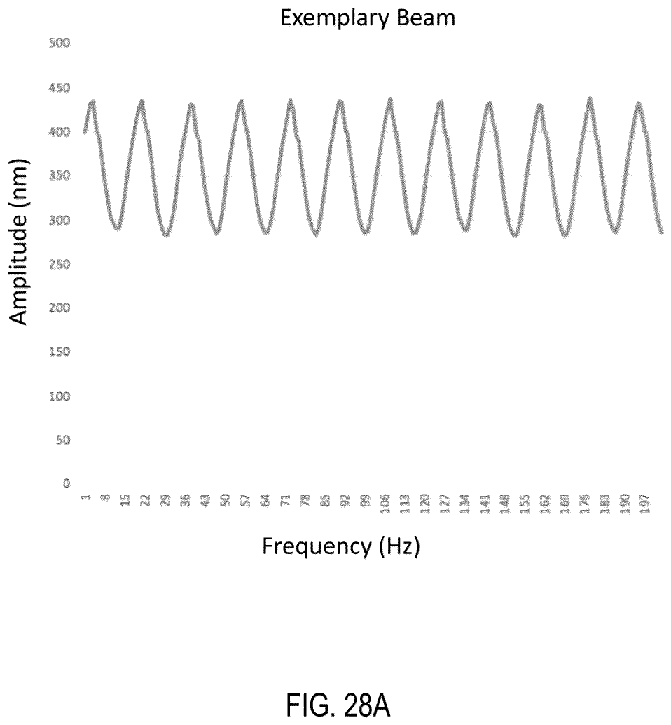

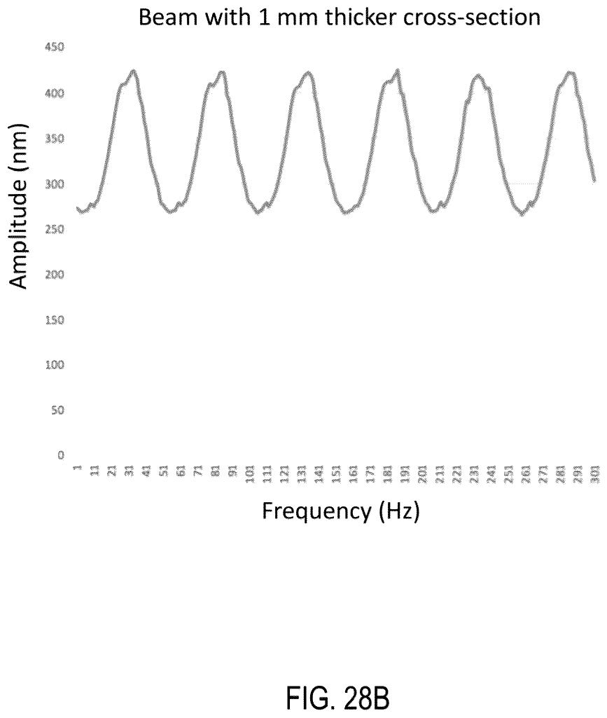

The calculated or determined natural frequency of beam 9062 or beam 9062 plus coupling element 9064 can then be used to tune a frequency of oscillation of motor 9054. As will be described in further detail in connection with FIGS. 27-28B, even small changes or adjustments in the dimensions or geometry of beam 9062 can have profound effects on the natural frequency of beam 9062 and thus the frequency to which motor 9054 is tuned.

In some embodiments, oscillation frequency based on beam dimensions is simulated to account for a shape of beam 9062 and a motor 9054 mounted to the end of beam 9062 to model the complex geometries of beam 9062 and heterogenous material properties of beam 9062.

Turning now to FIG. 27. FIG. 27 depicts a test fixture 9070 for testing a device, for example device 9030 or any device described elsewhere herein, to determine a force output of device 9030. Text fixture 9070 includes a frame 9078 including holder 9092, two or more members 9082, sensor 9084, and plate 906. The two or more members 9082 are coupled to plate 9086 at a first end 9088a and to frame 9078 at a second end 9088b. Members 9082 suspend plate 9086 in frame 9078, as shown in FIG. 27. In some embodiments, members 9082 are elastic; in other embodiments, members 9082 are more rigid or inflexible. The material of members 9082 is dictated by a type of test to be conducted with test fixture 9070. Device 9030, or any device described elsewhere herein, rests in holder 9092 of frame 9078 during testing. Plate 9086 is a contact surface for effector tip 9018 during testing and includes one or sensors 9084. In some embodiments, sensor 9084 is a motion sensor (e.g., accelerometer, gyroscope, etc.); in other embodiments, sensor 9084 is a force sensor, pressure sensor, camera, temperature sensor, touch sensor, proximity sensor, optical sensor, colorimeter, tactile sensor, or any other sensor known in the art.

In the example shown in FIGS. 28A-28B, effector tip 9018 of device 9030 contacts sensor 9084, an accelerometer, on plate 9086 of text fixture 9070. The sensor 9084 measures the dynamic acceleration of effector tip 9018 as a voltage, which can then be used to calculate or estimate a force exerted by effector tip 9018. Since plate 9086 and sensor 9084 have a known mass, an output force of effector tip 9018 can be estimated using the following equation (2):

$$F = m * a \qquad ( 2 )$$

where F is the output force of effector tip 9018,
m is a combined mass of plate 9086 and sensor 9084, and
a is the acceleration as measured by sensor 9084.

The dynamic acceleration, shown as amplitude vs. frequency, of exemplary beam 9062 of device 9030 is shown in FIG. 28A and a beam with a thicker cross-section is shown in FIG. 28B. As shown in FIG. 28A, the geometry of the beam was selected to have a desired output frequency (Hz) and amplitude (mm), for example substantially 270 Hz and 148 mm, to produce a desired therapeutic effect elicited by effector tip 9018 of device 9030. In contrast, changing the geometry of the beam, even by 1 mm, drastically changes a frequency of effector tip oscillation. For example, as shown in FIG. 28B, increasing a thickness of the beam cross-section by 1 mm drastically reduced a frequency of effector tip oscillation (from substantially 230 Hz to substantially 78 Hz). Using test fixture 9070 for commercially available devices reveals that these devices do not result in the same motion, frequency, amplitude, and/or force as device 9030. For example, commercially available back massage devices, Sonicare® devices, or devices using reciprocal motors to elicit beam movement do not output the correct motion or skin interface, nor the correct frequency, force, and/or amplitude to elicit a beneficial, atraumatic, and/or quiet therapeutic effect. As a consequence, these other commercially available devices do not deliver the therapeutic effect of inducing tears or providing relief from congestion, for example rhinosinusitis.

TABLE 1
Function and Efficacy of Commercially Available Devices

| | Frequency | Force | Clinical | Shape of |
|---|---|---|---|---|
| Device | (Hz) | Output | Efficacy | interface |
| iTEARgen1 | 180 | 180 | Minimal | 90 degree angle |
| iTEARgen2 | 270 | 180 | Yes | 90 degree angle |
| Sonicare | 263 | 85 | Minimal | Smooth |
| Dr. Johnson | 130 | 141 | No | Smooth/Rounded |
| Wahl Deep | 90 | 95 | No | Smooth/Rounded |
| Tissue | | | | |
| Evolved | 127 | 180 | No | Smooth/Rounded |
| First Time | 141 | 80 | No | Smooth/Rounded |

Table 1 above relates force and frequency measured by the test fixture 9070 to clinical efficacy in a selection of commercially available devices. The tips of the devices and the shape of the tips were chosen from a larger group of commercially available devices due to their potential to activate nerves related to lacrimation and nasal decongestion. The clinical efficacy is an increase in tearing from the lacrimal gland and a decrease in nasal congestion. As shown in Table 1, very few devices that were tested were clinically effective. This lack of clinical efficacy is likely due to the shape of the interface and the combined force and frequency output of the effector tip.

As shown in Table 1, iTEARgen1 was modestly effective in stimulating tear production and iTEARgen2 was more effective than iTEARgen1, producing the desired clinical effect in over 99% of patients. The frequency, force, and movement of iTEARgen2 makes it a significantly improved device compared to iTEARgen1. However, both are significantly better than commercially available massager devices which serve other purposes. The other devices (i.e., Sonicare, Dr. Johnson, Walh Deep Tissue, Evolved, First Time) in Table 1 are commercial devices sold as massagers for various body regions.

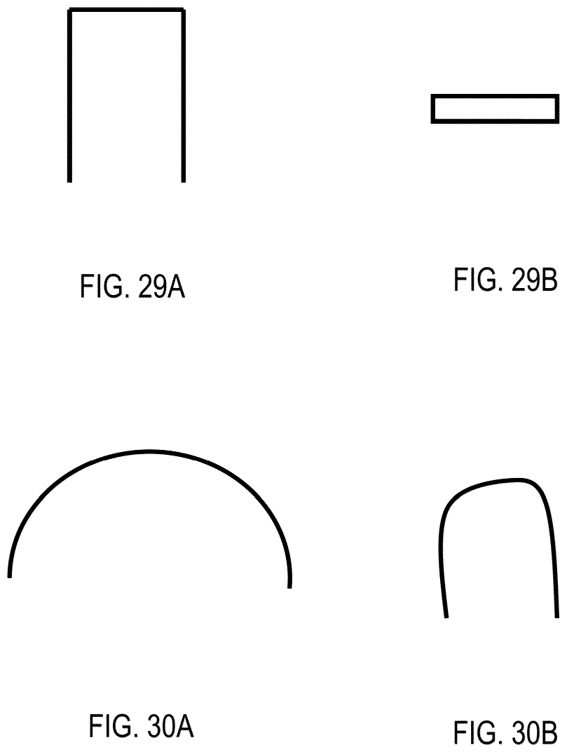

FIGS. 29A-29B depict various views of an effector tip, similar to the effector tip of iTEARgen1 and gen2, which was successful in clinical efficacy. As shown in FIGS. 29A-29B, the effector tip has sharp, 90 degree edges. In contrast, FIGS. 30A-30B depict various views of an end effector, which was clinically ineffective. As shown in FIGS. 30A-30B, the effector tip has rounded or smooth surfaces. As described herein with respect to device 9030 of FIGS. 21-26 and in direct contrast to the results presented in Table 1, the effector tip 9018 of device 9030 achieves clinical efficacy while also having a narrow smooth surface with defined edges on the effector tip 9018. Such efficacy is due in part to the shape and composition of the effector tip 9018 but also the unique mechanisms (e.g., eccentric motor, beam, etc.) of device 9030 that are used to induce effector tip 9018 vibration/oscillation.

There are additional differences between the commercially available devices which do not have an indication for dry eye and which do not work for dry eye. For example, effector tips on the commercially available devices do not move independently from the housing on the device. Such an arrangement is necessarily inefficient because the entire housing vibrates as opposed to all the force being delivered to the interface by the effector tip. In other words, the pressure is lower over the larger surface of the device which is less effective than higher pressure over the smaller surface area of the effector tip. In the currently described device 9030, the effector tip 9018 moves independently from the housing 9024, oscillating in and out of the housing or substantially outside the housing to apply its therapeutic benefit and maximizing the force applied to the patient's external nasal nerve. The motor 9054 is inside the housing 9024 and communicates with the effector tip 9018 through a physical connection which might be a mechanical linkage, an electromagnetic coupling, or a direct connection to the effector tip 9018. The housing 9024 is merely required so that the operator can hold the device 9030.

### Accessory Device

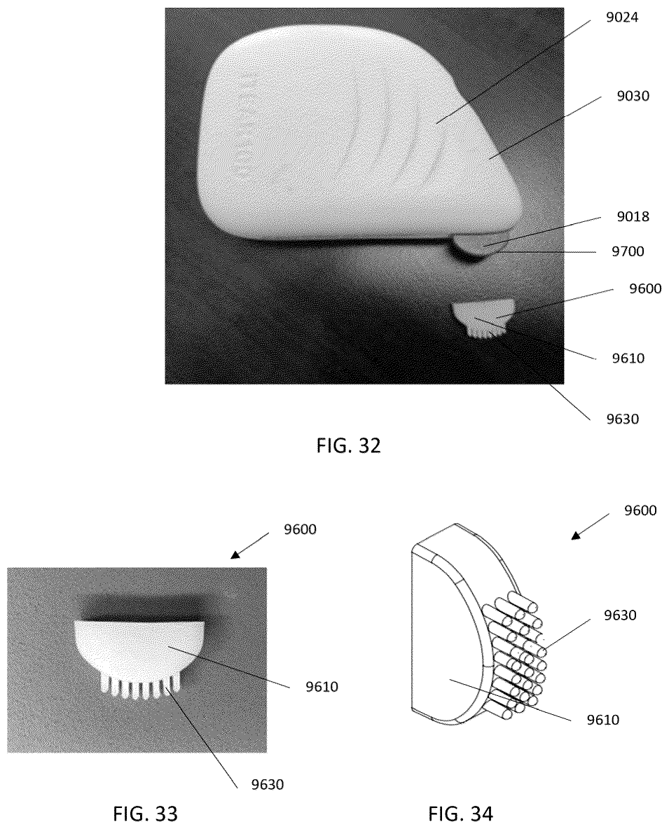

In some cases, an accessory device may be provided to couple with an end-effector of any of the vibration devices described herein. FIG. 32 shows a vibration device 9030 with an end effector 9018, and an accessory device 9600. The vibration device 9030 is the vibration device 9030 described with reference to FIGS. 21-26, and the end effector 9018 is the effector tip 9018 described previously. In the illustrated embodiments of FIG. 32, the end-effector 9018 is outside the housing 9024 of the vibration device 9030. The accessory device 9600 is configured to detachably couple with the end effector 9018, so that when the vibration device 9030 vibrates the end-effector 9018, the accessory device 9600 will also be vibrated along with the end-effector 9018 to provide a therapeutic effect for the user. The end-effector 9018 is configured for placement on an exterior surface (e.g., the skin) of the user during use. In some cases, the vibration device 9030 and the accessory device 9600 may together form a system.

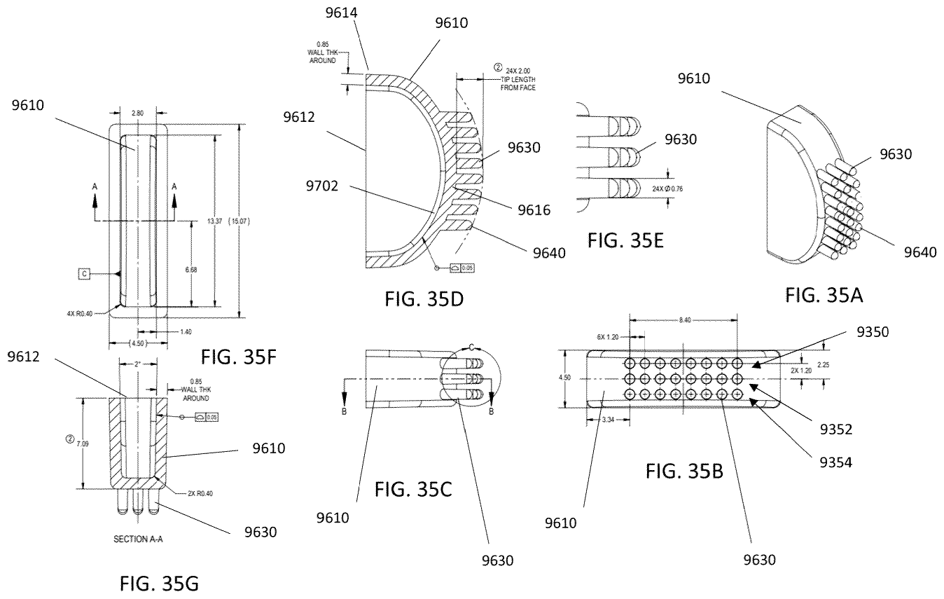

FIG. 33 shows a side view of the accessory device 9600 of FIG. 32. FIG. 34 shows a perspective view of the accessory device 9600 of FIG. 32. FIG. 35A shows a perspective view of the accessory device 9600 of FIG. 32. FIG. 35B-35G shows exemplary dimensions of the accessory device 9600 of FIG. 32.

As shown in FIGS. 32-35, the accessory device 9600 includes: a housing 9610 configured to accommodate at least a part of the end-effector 9018. The housing 9610 comprising an opening 9612 configured to allow the part of the end-effector 9018 to be inserted therein. The accessory device 9600 also includes a plurality of bristles 9630 extending from the housing 9610.

In the illustrated example, the housing 9610 comprises a first end 9614, and a second end 9616 opposite from the first end 9614, wherein the opening 9612 is at the first end 9614 of the housing 9610. In other cases, the opening 9612 may be at any of other parts of the housing 9610.

Also, in the illustrated example, the bristles 9630 are at the second end 9616 of the housing 9610, and are opposite from the opening 9612 of the housing 9610. In other cases, the bristles 9300 and the opening 9612 may not be on opposite sides of the housing 9610. For example, in another example, the bristles 9630 may be on a side of the housing 9610 that is 90-degree, or any of other angles, with respect to the side of the housing 9610 where the opening 9612 is located.

As shown in FIGS. 34 and 35B, the plurality of bristles 9630 comprises a first row 9350 of bristles 9630 arranged in a first rectilinear configuration, a second row 9352 of bristles 9630 arranged in a second rectilinear configuration, and a third row 9354 of bristles 9630 arranged in a third rectilinear configuration. In other cases, the accessory device 9600 may include only two rows of bristles 9630 or only one row of bristles 9630. In further cases, the accessory device 9600 may include more than three rows of bristles 9630. Also, in the illustrated examples, the bristles 9630 are aligned in rows and columns to form a matrix. In other cases, the bristles 9630 may form a staggered configuration. For example, adjacent rows or columns of bristles 9630 may be offset with respect to each other.

In some cases, one or more (e.g., all) of the bristles 9630 may have a cross-sectional dimension that is less than 1 mm. In other cases, one or more (e.g., all) of the bristles 9630 may have a cross-sectional dimension that is larger than 0.5 mm. In further cases, one or more (e.g., all) of the bristles 9630 may have a cross-sectional dimension that is larger than 1 mm. Also, in the illustrated example, all of the bristles 9630 have the same cross-sectional dimension. In other examples, one or more of the bristles 9630 may have a first cross-sectional dimension, and another one or more of the bristles 9630 may have a second cross-sectional dimension that is different from (e.g., larger or smaller than) the first cross-sectional dimension.

In some cases, one or more (e.g., all) of the bristles 9630 may have a length that is 2 mm. In other cases, one or more (e.g., all) of the bristles 9630 may have a length that is longer than 2 mm. In further cases, one or more of the bristles 9630 may have a length that is shorter than 2 mm. Also, in the illustrated example, all of the bristles 9630 have the same length. In other examples, one or more of the bristles 9630 may have a first length, and another one or more of the bristles 9630 may have a second length that is different from (e.g., longer or shorter than) the first length.

In some cases, the accessory device 9600 may have a total of 24 bristles 9630. In other cases, the accessory device 9600 may have more than 24 bristles 9630. In further cases, the accessory device 9600 may have fewer than 24 bristles 9630. In the illustrated example, the bristles 9630 comprise respective tips 9640, and wherein the tips 9640 of the respective bristles 9630 define a curvilinear surface. In other cases, the tips 9640 of the respective bristles 9630 may define a rectilinear surface. In further cases, the tips 9640 of the respective bristles 9630 may define a surface having an irregular shape.

In some cases, at least one (or each) of the bristles 9630 may have a flexibility that allows a tip of the bristle 9630 to bend in any direction (e.g., any perpendicular direction) with respect to the longitudinal axis of the bristles. The tip of the bristles may displace by at least 1 mm in response to a 0.5N force or less (e.g., 0.4N), or at least 3 mm in response to a 1.2N force, or at least 7 mm in response to 5N force or less, applied at the tip in any direction that is perpendicular to a longitudinal axis of the bristle 9630. Thus, the accessory device 9600 provides a softer interface to interact with a skin of the user compared to that of the end-effector 9018. In other cases, the bristles 9630 may have other levels of flexibility. For examples, in other embodiments, each bristle 9630 may be more flexible or less flexible (e.g., stiffer) compared to the above described level of flexibility.

In the illustrated embodiments, the end-effector 9018 has a curvilinear surface 9700 (shown in FIG. 32). The housing 9610 of the accessory device 9600 may have an inner surface 9702 (shown in FIG. 35D) that corresponds with the curvilinear surface 9700 of the end-effector 9018. In other embodiments, the end-effector 9018 may have different configurations. For example, the end-effector 9018 may not have a curvilinear surface in other embodiments. Also, in other embodiments, the housing 9610 of the accessory device 9600 may have an inner surface that does not correspond with a surface of the end-effector 9018.

In some cases, the housing 9610 may have a wall thickness that is anywhere from 0.25 mm to 1.5 mm. For example, as shown in FIGS. 35D and 35G, the wall thickness of the housing may be 0.85 mm. In other cases, the housing 9610 may have a wall thickness that is larger than 1.5 mm. In further cases, the housing 9610 may have a wall thickness that is less than 0.25 mm.

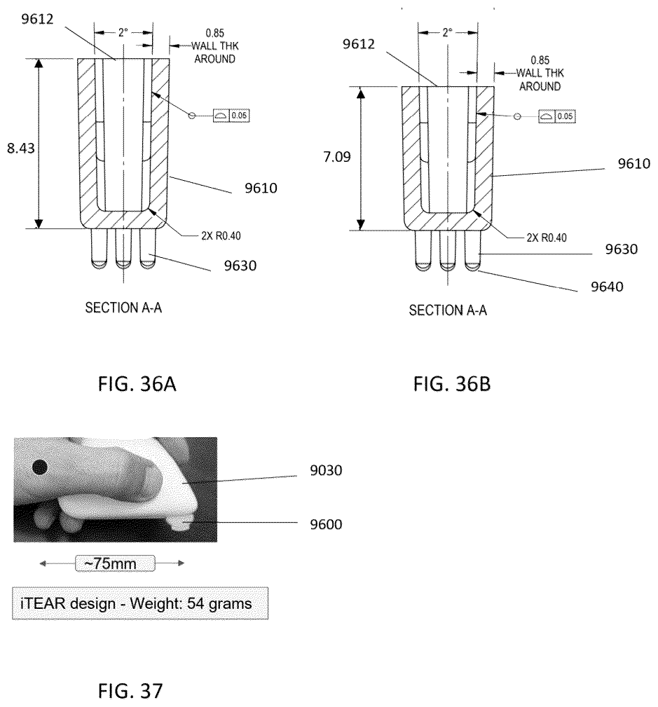

Also, in some cases, the housing 9610 of the accessory device 9600 may have an outer dimension measured in a direction that is parallel to one of the bristles 9630, wherein the outer dimension may be anywhere from 5 mm to 9 mm. For example, as shown in FIG. 36A, the outer dimension may be 8.43 mm. As another example, as shown in FIG. 36B, the outer dimension may be 7.09 mm. Also, in some cases, the outer dimension of the housing 9610 may have a value that prevents the housing 9610 of the accessory device 9600 from abutting against the housing 9024 of the vibration device 9030, thereby preventing an increase of operating noise due to components interference. The housing 9610 of the accessory device 9600 may be configured to detachably attach to the end-effector 9018 of the vibration device 9030 using different techniques in different embodiments. For example, the housing 9610 of the accessory device 9600 may be configured to attach to a part of the end-effector 9018 via friction. Such may be accomplished by configuring the housing 9610 to have certain stiffness, elasticity, and/or tolerance (with respect to the end-effector 9018), so that the housing 9610 can be easily placed over the end-effector 9018, while stay coupled to the end-effector 9018 while the end-effector 9018 vibrates during use. The stiffness and/or elasticity of the housing 9610 may be achieved using the appropriate material (e.g., material with certain minimum modulus of elasticity) and/or by creating the housing 9610 to have certain wall thickness. In some embodiments, the housing 9610 of the accessory device 9600 is configured to stay coupled to the end-effector 9018 via friction without detaching f when the end-effector vibrates at 100 Hz, 200 Hz, 300 Hz, or higher. As another example, the housing 9610 of the accessory device 9600 may be configured to attach to a part of the end-effector 9018 via an adhesive. The adhesive may be implemented using one or more double-sided tapes, glue, or any of other types of adhesive. The adhesive may be located on the inner surface of the wall of the housing 9610. In some cases, the adhesive may be pre-applied on the inner surface. In other cases, the adhesive may be provided in a container (e.g., bottle, bag, etc.) for the user to apply onto the inner surface. In the example in which the adhesive is implemented using one or more double-sided tapes, the one or more double-sided tapes may be located on the inner surface of the wall of the housing 9610. In one implementation, the accessory device 9600 may have one double-sided tape on a major inner surface of the housing 9610. In another implementation, the accessory device 9600 may have two double-sided tapes on opposite inner surfaces of the housing 9610.

As a further example, the housing 9610 of the accessory device 9600 may be configured to attach to a part of the end-effector 9018 via a mechanical coupler. By means of non-limiting examples, the mechanical coupler may be a clip, a clamp, a pin-connector, a screw-connector, a snap-fit connector, or any of other connectors. In some cases, the housing 9610 of the accessory device 9600 is configured to attach to the part of the end effector 9018 with a coupling force that is sufficient to withstand a vibration of the end-effector 9018 at 100 Hz. In other cases, the housing 9610 of the accessory device 9600 is configured to attach to the part of the end-effector 9018 with a coupling force that is sufficient to withstand a vibration of the end effector 9018 at 200 Hz. In further cases, the housing 9610 is configured to attach to the part of the end-effector 9018 with a coupling force that is sufficient to withstand a vibration of the end effector 9018 at 300 Hz.

In some embodiments, the housing 9610 of the accessory device 9600 may be implemented as an elastomeric cover or lid configured to slip over a part of the end-effector 9018, held by frictional force. In other embodiments, the housing 9610 may be made from other materials. By means of non-limiting examples, the housing 9610 of the accessory device 9600 may be made from any polymer, plastic, silicone, rubber, any biocompatible material, etc.

Also, in some embodiments, the bristles 9630 may be made from the same material as that of the housing 9610 of the accessory device 9600. By means of non-limiting examples, the bristles 9630 may be made from an elastomeric material, polymer, plastic, silicone, rubber, any biocompatible material, etc. In other embodiments, the bristles 9630 and the housing 9610 of the accessory device 9600 may be made from different respective materials. For example, the material of the housing 9610 may be stiffer than the material of the bristles 9630, or vice versa.

In the illustrated embodiments, the end-effector 9018 is configured to vibrate by moving back and forth along a trajectory (direction) that is substantially parallel (e.g., at an angle that is anywhere within the range of 0 degree+/−5 degrees with respect) to a longitudinal axis of at least one of the bristles 9630. In particular, the bristles 9630 are oriented relative to the housing 9610 such that when the accessory device 9600 is coupled with the end-effector 9018 of the vibration device, the bristles 9630 will be vibrated to move in a direction that is substantially parallel (e.g., at an angle that is anywhere within the range of 0 degree+/−5 degrees with respect) to the longitudinal axes of the bristles 9630. In other embodiments, the bristles 9630 may be vibrated to move in a direction that is more than 5-degrees with respect to the longitudinal axes of the bristles 9630.

In the illustrated embodiments, the vibration device 9030 is configured to provide mechanical vibration to treat a dry eye condition of a user. In such cases, the bristles 9630 are configured to stimulate the meibomian glands when the bristles 9630 are vibrated by the vibration device 9030. Alternatively or additionally, the bristles 9630 may be applied at the margin of the eye to clean the meibomian glands.

In a preferred embodiment, the bristles 9630 are configured to brush the meibomian glands to remove or scrape away any inspissated material, and can simultaneously stimulate secretion from the glands. The bristles 9630 may be configured to gently accomplish these goals and optionally retain a gel or other liquid.

In other embodiments, the vibration device 9030 may be configured to provide mechanical vibration to treat other conditions. Also, in other embodiments, the bristles 9630 may be configured for placement at other parts of the user.

In some embodiments, the accessory device 9600 may be configured for a certain body part. For example, the accessory device 9600 may have a shape and/or the bristles 9630 may have certain characteristic(s) designed to apply energy at certain body part (e.g., eyelid, nose, forehead, etc.). The configuration (e.g., length, cross-sectional width, cross-sectional shape, bending flexibility, arrangement, etc.) of the bristles 9630 may be designed for different applications in different embodiments. For example, the accessory device 9600 may have more or fewer bristles 9630, the bristles 9630 may be longer or shorter, and/or the bristles 9630 may be made stiffer or softer, etc., in order to configure the accessory device 9600 for certain application.

Also, in some embodiments, the bristles 9630 may be configured to amplify or enhance the effect of the stimulation on the eyelids by the vibration device.

In some embodiments, the accessory device 9600 may be provided individually. In other embodiments, multiple accessory devices 9600 may be provided in a package, which allows the user to replace the accessory device 9600 when it is worn out. For example, a pack of accessory devices 9600 may include 50 accessory devices 9600. In other embodiments, a pack of the accessory devices 9600 may include fewer than 50 accessory devices 9600 or more than 50 accessory devices 9600.

In the above embodiments, the accessory device 9600 is described as having bristles 9630. The bristles 9630 are accessory end-effector configured to provide a treatment effect for a user of the vibration device 9030. The treatment effect provided by the accessory end-effector of the accessory device 9600 is different from the treatment effect provided by the end-effector of the vibration device 9030. In other embodiments, the accessory end-effector of the accessory device 9600 may not be bristles. Instead, in other embodiments, the accessory end-effector of the accessory device 9600 may be other structure(s) configured to contact the user to provide a treatment effect for the user. For example, in other embodiments, the accessory end-effector may have a surface with a curvature that is different from that of the end-effector of the vibration device 9030. As another example, in other embodiments, the accessory end-effector may include one or more short protrusions. As a further example, the accessory end-effector may include a surface texture that is different from that of the end-effector of the vibration device 9030.

Also, in some cases, the accessory devices 9600 may be sterilized (e.g. ETO sterilized) according to ISO 11135. The accessory device 9600 may be provided as a daily disposable product. In such cases, a cleaning protocol is not required. In other embodiments, the accessory device 9600 may be cleaned periodically, and may be used for more than one day.

As described above, the accessory device 9600 is configured to couple with the end effector 9018 of the vibration device 9030 of FIGS. 21-26. As shown in FIGS. 21-26, in some embodiments, the vibration device 9030 comprises: a housing 9024; a member 9062 having a first portion accommodated in the housing 9024, and a second portion that is moveable relative to the housing 9024. The second portion of the member 9062 is for placement outside a user and comprises the end-effector 9018. The member 9062 has an elongated configuration. The vibration device 9030 also includes a motor 9054 in the housing 9024, wherein the motor 9054 is configured to oscillate the member 9062.

In some embodiments, the motor 9054 may be carried by the member 9062. In particular, the motor 9054 may be fixedly attached to the member 9062 so that the motor 9054 and the member 9062 can move together. In such cases, the weight of the motor 9054 is supported by the member 9062. In one implementation, the motor 9054 may have a motor housing, and the motor housing is attached to the member 9062. The motor 9054 may comprise a shaft, and the vibration device 9030 comprises an eccentric mass secured to a shaft of the motor 9054.

In some cases, the vibration device 9030 may include an electrical wire connected to the motor 9054. In such cases, at least a portion of the electrical wire may be coupled to the member 9062, or may be coupled to other component(s) in the housing 9024 of the vibration device 9030.

In some embodiments, the member 9062 comprises a cantilevered beam 9062 having a free end, and the second portion of the member 9062 is at the free end of the cantilevered beam 9062. In other embodiments, the member 9062 may be a beam supported at opposite ends of the member 9062. In further embodiments, the member 9062 may not be a beam, and may have other shapes and configurations.

Also, in some embodiments, the member 9062 has a first bending stiffness in a first bending direction, and a second bending stiffness in a second bending direction, the second bending stiffness being higher than the first bending stiffness. In some cases, the first bending direction corresponds with a direction of oscillation of the member 9062.

In addition, the member 9062 may have a cross section with a first side and a second side, the first side being longer than the second side. The motor 9054 may be attached to the first side of the member 9062. Alternatively, the motor 9054 may be attached to the second side of the member 9062. In further embodiments, the motor 9054 and the member 9062 may not be fixedly attached to each other. For example, in further embodiments, the member 9062 may be moveably (e.g., slidably and/or rotatably) coupled to the motor 9054.

As shown in FIG. 37, the vibration device 9030 with the accessory device 9600 may have a weight of 54 grams. In other cases, the vibration device 9030 with the accessory device 9600 may have a weight that is higher than 54 grams or less than 54 grams. Assuming a pivot at mid-hand, the vibration device 9030 has a lever arm of less than 100 mm (e.g., 75 mm). This configuration is advantageous because it reduces user fatigue due to the center-of-mass of the vibration device 9030 being close to a center of the palm of the user. In other embodiments, the vibration device 9030 with the accessory device 9600 may have a center-of-mass that is within 50 mm from a center of the palm of the user. Such may be accomplished by making the vibration device 9030 not too long, and/or by making the end-effector 9018 close to the tip of the thumb. This is advantageous because it may allow user with tremor to still effectively use the vibration device 9030 while applying fine motion.

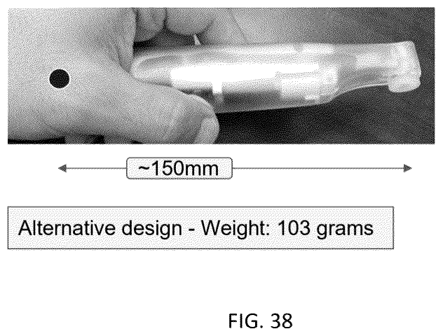

FIG. 38 illustrates another vibration device 9900. The vibration device 9900 includes a handle set back from the motorized implement. The handle being set back creates a lever arm so that when applied to the eyelids, a small movement at the point of hand contact leads to a large movement at the eyelid. Eyelid care appliances with similar configuration have also been described in U.S. Pat. Nos. 10,314,763, and 10,821,022.

The vibration device 9030 with the accessory device 9600 has several advantages over the vibration device 9900 of FIG. 38. First, the vibration device 9030 retrofitted with the accessory device 9600 has a much smaller lever arm (compared to the vibration device 9900) when applied to the eyelids. This allows the user to more easily and accurately place the end-effector of the accessory device 9600 at the target location(s) (e.g., eyelids). Also, the tip of the vibration device 9030 can be depressed inward with greater force. In addition, the accessory device 9600 is advantageous because it allows the vibration device 9030 (with its end-effector configured to provide a first treatment effect) to provide second treatment effect that is different from the first treatment effect. For example, in some embodiments, the end-effector of the vibration device 9030 may be configured to stimulate nerves at a nose region to treat dry eye condition and/or sinus condition, and the accessory device 9600 may be configured to stimulate and/or to clean the meibomian glands. Also, in some embodiments, the end effector of the vibration device 9030 may be configured to treat a first medical condition, and the accessory end-effector of the accessory device 9600 may be configured to treat a second medical condition that is different from the first medical condition. Thus, the accessory device 9600 provides a convenient and cost-effective way to enhance the functionalities of the vibration device 9030. In some cases, the accessory end-effector of the accessory device 9600 may be configured to replace, enhance, or modify a function of the end-effector of the vibration device 9030.

In some embodiments, the operating noise of the vibration device with the accessory device 9600 is about 41 dB measured at 1 m away from the vibration device. In other embodiments, the operating noise of the vibration device with the accessory device 9600 may have other noise levels.

In other embodiments, the accessory device 9600 may be used with other vibration devices, and is not limited for use with the vibration device 9030 described herein. In one or more embodiments described herein, the device may be designed with low cost and form factor, which encourages compliance and facilitates its utilization. As used in the description and claims, the singular form “a”, “an” and “the” include both singular and plural references unless the context clearly dictates otherwise. For example, the term “effector” may include, and is contemplated to include, a plurality of effector tips. At times, the claims and disclosure may include terms such as “a plurality,” “one or more,” or “at least one;” however, the absence of such terms is not intended to mean, and should not be interpreted to mean, that a plurality is not conceived.

The term “about” or “approximately,” when used before a numerical designation or range (e.g., to define a length or pressure), indicates approximations which may vary by (+) or (−) 10%, 5%, 1% 0.1%, or 0%. All numerical ranges provided herein are inclusive of the stated start and end numbers. The term “substantially” indicates mostly (i.e., greater than 50%) or essentially all of a device, substance, composition, a metric, a value, a parameter, etc.

As used herein, the term “comprising” or “comprises” is intended to mean that the devices, systems, and methods include the recited elements, and may additionally include any other elements. “Consisting essentially of” shall mean that the devices, systems, and methods include the recited elements and exclude other elements of essential significance to the combination for the stated purpose. Thus, a system or method consisting essentially of the elements as defined herein would not exclude other materials, features, or steps that do not materially affect the basic and novel characteristic(s) of the claimed disclosure. “Consisting of” shall mean that the devices, systems, and methods include the recited elements and exclude anything more than a trivial or inconsequential element or step. Embodiments defined by each of these transitional terms are within the scope of this disclosure.

The examples and illustrations included herein show, by way of illustration and not of limitation, specific embodiments in which the subject matter may be practiced. Other embodiments may be utilized and derived therefrom, such that structural and logical substitutions and changes may be made without departing from the scope of this disclosure. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Although particular embodiments have been shown and described, it will be understood that it is not intended to limit the claimed inventions to the preferred embodiments, and it will be obvious to those skilled in the art that various changes and modifications may be made without department from the spirit and scope of the claimed inventions. The specification and drawings are, accordingly, to be regarded in an illustrative rather than restrictive sense. The claimed inventions are intended to cover alternatives, modifications, and equivalents.

What is claimed is:

1. An accessory device for coupling with an end-effector of a vibration device, the end-effector of the vibration device configured to provide a first treatment effect for a user of the vibration device, the accessory device comprising:
a housing configured to accommodate at least a part of the end-effector, the housing comprising an opening configured to allow the part of the end-effector to be inserted therein; and
an accessory end-effector extending from the housing, wherein the accessory end-effector is configured to provide a second treatment effect for the user of the vibration device that is different from the first treatment effect.

2. The accessory device of claim 1, wherein the housing comprises a first end, and a second end opposite from the first end, wherein the opening is at the first end of the housing.

3. The accessory device of claim 1, wherein the accessory end-effector comprises a plurality of bristles.

4. The accessory device of claim 3, wherein the bristles are at the second end of the housing, and are opposite from the first opening.

5. The accessory device of claim 3, wherein the bristles are configured to be vibrated by the vibration device in a direction that is parallel to a longitudinal axis of one of the bristles, when the accessory device is coupled to the vibration device.

6. The accessory device of claim 3, wherein the plurality of bristles comprises a first row of bristles arranged in a first rectilinear configuration.

7. The accessory device of claim 6, wherein the plurality of bristles further comprises a second row of bristles arranged in a second rectilinear configuration.

8. The accessory device of claim 6, wherein the plurality of bristles further comprises a third row of bristles arranged in a third rectilinear configuration.

9. The accessory device of claim 3, wherein at least one of the bristles has a cross-sectional dimension that is less than 1 mm.

10. The accessory device of claim 3, wherein at least one of the bristles has a cross-sectional dimension that is larger than 0.5 mm.

11. The accessory device of claim 3, wherein at least one of the bristles has a cross-sectional dimension that is larger than 1 mm.

12. The accessory device of claim 3, wherein at least one of the bristles has a length that is 2 mm.

13. The accessory device of claim 3, wherein at least one of the bristles has a length that is longer than 2 mm.

14. The accessory device of claim 3, wherein at least one of the bristles has a length that is shorter than 2 mm.

15. The accessory device of claim 3, wherein the plurality of bristles comprises 24 bristles.

16. The accessory device of claim 3, wherein the plurality of bristles comprises more than 24 bristles.

17. The accessory device of claim 3, wherein the plurality of bristles comprises fewer than 24 bristles.

18. The accessory device of claim 3, wherein the bristles comprise respective tips, and wherein the tips of the respective bristles define a curvilinear surface.

19. The accessory device of claim 3, wherein one of the bristle has a flexibility that allows a tip of the one of the bristles to displace by at least 1 mm in response to a 0.5N force applied at the tip in a direction that is perpendicular to a longitudinal axis of the one of the bristles.

20. The accessory device of claim 3, wherein the housing has an outer dimension measured in a direction that is parallel to one of the bristles, the outer dimension being anywhere from 5 mm to 9 mm.

21. The accessory device of claim 3, wherein the bristles are configured to stimulate the meibomian glands when the bristles are vibrated by the vibration device.

22. The accessory device of claim 1, wherein the housing has a wall thickness that is anywhere from 0.25 mm to 1.5 mm.

23. The accessory device of claim 1, wherein the housing is configured to attach to the part of the end-effector via friction.

24. The accessory device of claim 1, wherein the housing is configured to attach to the part of the end-effector via a double-sided tape.

25. The accessory device of claim 1, wherein the housing is configured to attach to the part of the end-effector via an adhesive.

26. The accessory device of claim 1, wherein the housing is configured to attach to the part of the end-effector via a mechanical coupler.

27. The accessory device of claim 1, wherein the housing is configured to attach to the part of the end effector with a coupling force that is sufficient to withstand a vibration of the end-effector at 100 Hz.

28. The accessory device of claim 1, wherein the housing is configured to attach to the part of the end-effector with a coupling force that is sufficient to withstand a vibration of the end effector at 200 Hz.

29. The accessory device of claim 1, wherein the housing is configured to attach to the part of the end-effector with a coupling force that is sufficient to withstand a vibration of the end effector at 300 Hz.

30. The accessory device of claim 1, wherein the accessory end-effector is configured to replace, enhance, or alter a function of the end-effector of the vibration device.

31. A system comprising the accessory device of claim 1, and the vibration device.

32. The system of claim 31, wherein the vibration device is configured to provide mechanical vibration to treat a dry eye condition of a user.

33. The system of claim 31, wherein the vibration device comprises:
a housing;
a member having a first portion accommodated in the housing, and a second portion that is moveable relative to the housing, wherein the second portion is for placement outside a user and comprises the end-effector, the member having an elongated configuration; and
a motor in the housing, the motor configured to oscillate the member.

34. The system of claim 31, wherein the motor is carried by the member.

35. The system of claim 31, wherein the motor is fixedly attached to the member so that the motor and the member can move together.

36. The system of claim 31, wherein the member comprises a cantilevered beam having a free end, the second portion being at the free end of the cantilevered beam.

37. The system of claim 31, wherein a weight of the motor is supported by the member.

38. The system of claim 31, wherein the motor has a motor housing, and the motor housing is attached to the member.

39. The system of claim 31, wherein the motor comprises a shaft, and the vibration device comprises an eccentric mass secured to a shaft of the motor.

40. The system of claim 31, wherein the vibration device comprises an electrical wire connected to the motor, wherein at least a portion of the electrical wire is coupled to the member.

41. The system of claim 31, wherein the member has a first bending stiffness in a first bending direction, and a second bending stiffness in a second bending direction, the second bending stiffness being higher than the first bending stiffness.

42. The system of claim 41, wherein the first bending direction corresponds with a direction of oscillation of the member.

43. The system of claim 31, wherein the member has a cross section with a first side and a second side, the first side being longer than the second side, and wherein the motor is attached to the first side.

44. The system of claim 31, wherein the end-effector has a curvilinear surface.

45. The system of claim 31, wherein the end-effector is outside the housing.
